(19) United States
(12) Patent Application Publication
(10) Pub. No.: US 2017/0061807 A1
(43) Pub. Date: Mar. 2, 2017

(54) SIGNAL PROCESSING SYSTEM FOR COMPARING A HUMAN-GENERATED SIGNAL TO A WILDLIFE CALL SIGNAL

(71) Applicants: Steven Philp, Laguna Niguel, CA (US); Karlton Bell, Irvine, CA (US); Mark Senefsky, Orange, CA (US); Terry Gniffke, Tustin, CA (US)

(72) Inventors: Steven Philp, Laguna Niguel, CA (US); Karlton Bell, Irvine, CA (US); Mark Senefsky, Orange, CA (US); Terry Gniffke, Tustin, CA (US)

(21) Appl. No.: 15/352,480

(22) Filed: Nov. 15, 2016

Related U.S. Application Data
(63) Continuation of application No. 14/451,100, filed on Aug. 4, 2014.
Application No. 14/451,100 is a continuation of application No. 14/449,687, filed on Aug. 1, 2014, now abandoned.
(60) Provisional application No. 61/861,088, filed on Aug. 1, 2013.

(51) Int. Cl. G09B 5/04; G09B 5/06

(52) U.S. Cl. CPC G09B 5/04; G09B 5/065

(57) ABSTRACT

Systems and methods for training users to more proficiently make wildlife calls, whether for hunting or other purposes, are described herein. For instance, an embodiment of an interactive learning system can train an enthusiast to more consistently and proficiently make calls that are efficacious with attracting wildlife. The system may implement advanced signal processing techniques that can compare a user-generated signal (attempting to mimic a wildlife call) with a prerecorded wildlife call. The system may provide feedback to the user to enable the user to assess his or her performance in reproducing the wildlife call. The user can use the feedback to improve reproduction of the wildlife call.

### RELATED APPLICATION

This application is a continuation of U.S. application Ser. No. 14/451,100, filed Aug. 4, 2014, which is a continuation of U.S. application Ser. No. 14/449,687, filed Aug. 1, 2014, which claims priority as a non-provisional application of U.S. Provisional Application No. 61/861,088, filed Aug. 1, 2013, the disclosures of which are hereby incorporated by reference in their entirety.

### BACKGROUND

Hunters and other wildlife enthusiasts pursuing their avocation often seek proximity to animals and birds (wildlife) in their natural habitats. Due to the animals and birds' defensive and preservation instincts however, achieving the desired distance to the wildlife can be difficult. While concealment and camouflage aids this effort, incorporating wildlife sounds and noises (calls) can be an effective technique that allows the human to gain the attention of the wildlife, overcome the innate tentativeness of the wildlife and have them positively respond to the source of the call.

### SUMMARY

For purposes of summarizing the disclosure, certain aspects, advantages and novel features of several embodiments are described herein. It is to be understood that not necessarily all such advantages can be achieved in accordance with any particular embodiment of the embodiments disclosed herein. Thus, the embodiments disclosed herein can be embodied or carried out in a manner that achieves or optimizes one advantage or group of advantages as taught herein without necessarily achieving other advantages as may be taught or suggested herein.

In certain embodiments, a method of conducting interactive training for producing a wildlife call can include: electronically generating a wildlife call training user interface for output on a display of a computing device, outputting master wildlife call audio associated with a master wildlife call with the computing device, and receiving practice audio input from a user via a microphone of the computing device. The practice audio input can include data representing a practice wildlife call; programmatically comparing at least one characteristic of the practice audio input with at least one characteristic of the master wildlife call audio. The method may also include assessing a quality of the practice wildlife call based at least in part on said comparing and electronically generating feedback output responsive to said assessing for presentation to the user.

In certain embodiments, the method of the preceding paragraph may be implemented together with any subcombination of the following features: the at least one characteristic of the practice audio input can include one or more of the following: volume, tone, pitch, rhythm, or length; the at least one characteristic of the practice audio input can include a sound characteristic specific to an animal associated with the master wildlife call audio; the feedback can include a score or rating; programmatically comparing can include applying a signal processing technique to analytically assess a degree of similarity between the at least one characteristic of the practice audio input with the at least one characteristic of the master wildlife call audio; the signal processing technique can include performing a spectral conversion of the practice audio input to produce a spectrally-converted practice audio input and comparing the spectrally-converted practice audio input with a spectrally-converted version of the master wildlife call audio; comparing of the spectrally-converted practice audio input with the spectrally-converted version of the master wildlife call audio can include calculating a minimum mean square error between the spectrally-converted practice audio input with the spectrally-converted version of the master wildlife call audio; the signal processing technique can include performing a mel spectrum analysis of the practice audio input and the master wildlife call audio; said programmatically comparing can include sending the practice audio input to a remote server and receiving data representing a comparison of the practice audio input and the master wildlife call from the remote server; the method can further include receiving the master wildlife call as audio input from a second user; the method can further include downloading or streaming the master wildlife call from a remote server; and the method can further include outputting an image of an animal that flees based on the feedback being negative.

In various embodiments, a system for conducting interactive training for producing a wildlife call can include a computing device including a hardware processor programmed with specific executable instructions that can output audio associated a master call including a reproduction of a call made by an animal, receive recorded input audio corresponding to a practice call made by a user in attempting to mimic the master call, programmatically compare the practice call with the master call, and electronically generate feedback responsive to the comparison for presentation to the user.

In certain embodiments, the system of the preceding paragraph may be implemented together with any subcombination of the following features: the feedback can include a score or rating; the computing device can also compare the practice call with the master call by comparing a characteristic of the practice call with a characteristic of the master call; the characteristic can include one or more of the following: volume, tone, pitch, rhythm, or length of the practice call; the feedback can include feedback regarding user performance on the characteristic; programmatic comparison can include a signal processing computation; the signal processing computation can include a spectral conversion of the practice call to produce a spectrally-converted practice call, and the signal processing computation further can include a minimum mean square error calculation between the spectrally-converted practice call and a spectrally-converted version of the master call; and the signal processing computation can include a mel spectrum computation with respect to the practice call and the master call.

### BRIEF DESCRIPTION OF THE DRAWINGS

Throughout the drawings, reference numbers are re-used to indicate correspondence between referenced elements. The drawings are provided to illustrate embodiments of the features described herein and not to limit the scope thereof.

FIG. 1 depicts an example computing environment for training users to make wildlife calls.

FIG. 2 depicts an example process for implementing an interactive learning system that trains training a user to make a wildlife call.

FIG. 3 depicts an example call collection.

FIG. 4 depicts an embodiment of a process for performing pre-spectral call analysis.

FIG. 5 depicts example segmented calls.

FIG. 6 depicts an embodiment of a process for performing spectral segment analysis.

FIG. 7 depicts another embodiment of a process for performing spectral segment analysis.

FIGS. 8 through 29 depict example user interfaces associated with a call trainer application.

### DETAILED DESCRIPTION

### I. Introduction

While personally developed sounds can be used to mimic wildlife, there are also many commercially produced devices that allow humans to generate calls attractive to animals and birds. However, proficiently replicating any such call to cause the desired response can be difficult and inconsistent. Attributes such as volume, tone, pitch and rhythm in a properly executed call can cause wildlife to draw nearer (the desired response). Alternatively, in a poorly attempted call, wildlife will likely flee or redirect their path due to a sense of confusion, uncertainty and self-preservation.

This disclosure describes embodiments of systems and methods for training users to more proficiently make wildlife calls, whether for hunting or other purposes. For instance, an embodiment of an interactive learning system can train an enthusiast to more consistently and proficiently make calls that are efficacious with attracting wildlife. The system may implement advanced signal processing techniques that can compare a user-generated signal (attempting to mimic a wildlife call) with a prerecorded wildlife call. The system may provide feedback to the user to enable the user to assess his or her performance in reproducing the wildlife call. The user can use the feedback to improve reproduction of the wildlife call.

As used herein, the term “call,” in addition to having its ordinary meaning, is used herein interchangeably to refer to a calling instrument and to refer to an animal sound created or mimicked using such a calling instrument. The particular meaning intended should be understood by the context in which the term is used.

### II. Overview of Wildlife Call Training Systems and Methods

Turning now to the FIGURES, specific embodiments of the interactive learning system and associated methods will now be described.

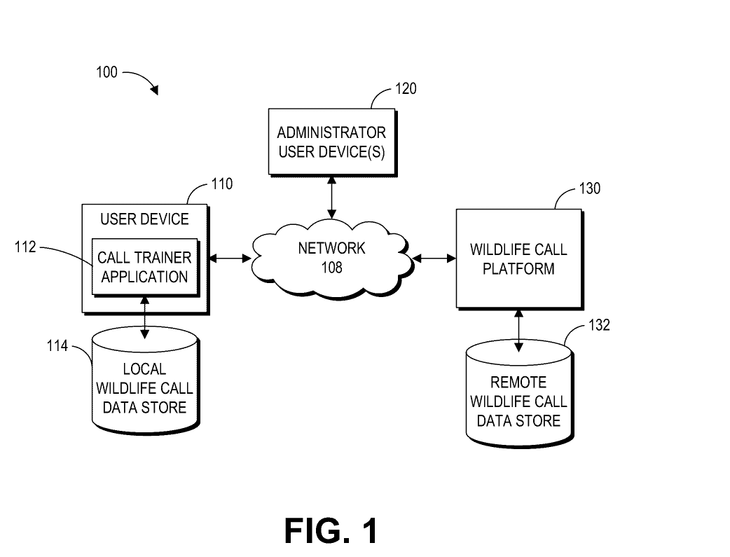

FIG. 1 depicts an example computing environment for implementing an interactive learning system 100 that can train users to make wildlife calls. FIG. 1 presents an overview embodiment of the interactive learning system 100 for wildlife call training. The interactive learning system 100 can be implemented in computer hardware and/or software.

For example, in the depicted embodiment, the interactive learning system 100 includes a call trainer application 112 and a wildlife call platform 130. The call trainer application 112 may be a mobile application or the like that is implemented on a user device 110, which may be a cell phone, smart phone, tablet, laptop, desktop, video game platform, television, kiosk, electronic book reader or “e-reader,” or any other computing device. The wildlife call platform 130 can be implemented as one or more servers and may be accessible to the call trainer application 112 over a network 108. The network 108 may be a local area network (LAN), wide area network (WAN), the Internet, a company intranet, combinations of the same or the like.

The call trainer application 112 can provide functionality for a user to select and listen to a master call, practice that call, and then receive feedback on the user's practice call. Initially, listening to a master call can enable a user to hear and understand the characteristics and nuances of a call. Once a user has attempted to mimic the master call, the user may use the call trainer application 112 to again listen to the master call, if desired, to identify any nuances the user may have missed when practicing the call.

Advantageously, in certain embodiments, the call trainer application 112 enables a user to record a wildlife practice call using a calling device (or the user's own voice) and automatically provides feedback on the practice call. The call trainer application 112 can electronically generate one or more user interfaces that provide the call training functionality described herein. The user interfaces can be accessed via touch screen input, mouse input, keyboard input, or any combination of the same, among others. A microphone in (or connected to) the user device can be used by the call trainer application 112 to record the user's voice or other user-generated sound during a practice call. The call trainer application 112 can compare the recorded practice call to a master recording of that type of call (often referred to herein as a master call). The system can assess the practice call based on a number of factors to determine how closely that practice call matches the master call and can output feedback to the user based on this determination.

The call trainer application 112 can access the master call from a local wildlife call data store 114 associated with the application 112. The call trainer application 112 and/or the local wildlife call data store 114 can be part of a mobile application that the user device downloads from a mobile application store, such as the Apple® App Store or the Google Play™ application store or the like. The user may also acquire the call trainer application 112 through other electronic media such as CDs, DVDs, etc. The call trainer application 112 may also be implemented in a browser instead of, or in addition to, in a mobile application.

In another embodiment, the call trainer application 112 can access the master call from the wildlife call platform 130 over the network 108. The master call may, for example, be stored in a remote wildlife call data store 132 in communication with the wildlife call platform 130. The call trainer application 112 can stream or download the call from the wildlife call platform 130. The wildlife call platform 130 may be implemented in a cloud computing platform (such as Amazon Web Services™, Microsoft Azure™, or the like), and the remote wildlife call data store 132 may be a cloud storage device in or in communication with the cloud computing platform. The wildlife call platform 130 can also offer master calls that can be purchased (or possibly accessed for free), as well as other related content. Master calls that are acquired by a user can be stored in the remote wildlife call data store 132 on behalf of the user or in the local wildlife call data store 114.

In another embodiment, the master call is recorded by another user who is proficient with the call. For instance, a user may have a friend or a coach who is training the user to perform a wildlife call. Such a user may create a master call using the call trainer application 112, and a user who is to practice that call may then attempt to mimic that call with the call trainer application 112. Optionally, the master call created using the call trainer application 112 can also be stored in the remote wildlife call data store 132 on behalf of the user or in the local wildlife call data store 114.

The call to be trained can relate to any of a number of different forms of wildlife, such as elk, deer, ducks, turkeys, other birds or fowl, moose, and the like, and may be for hunting purposes or animal observation purposes (such as to draw birds closer in bird watching or big game animals closer in for photographing). Each different form of wildlife may make one or more calls in their natural setting, and sometimes several calls combined that may be trained. The calls in certain embodiments attempt to mimic natural sounds that the animals produce in the wild. Elk, for example, make several sounds that may be mimicked by calls, include cow elk chirps, mews, and whines and bull elk bugles, chuckles, and grunts. Bull elk bugles may be further separated, for example, between locator, display or challenge bugles. To be effective in the field (e.g., on a hunt or animal watching expedition), a user should choose and introduce one or more of these calls depending on the specific conditions and proximity of the elk. The selected call should be properly executed to attract the animal and/or avoid frightening it off. For mew calls, this could mean a punctuated two-tone nasal sound or a desperate, repetitious pleading. For bugle calls, this could mean a single note locator bugle, an aggressive display bugle that finishes with a chuckle or grunt or a growly, intense challenge bugle which crescendos to a high pitch scream.

Human voices are not naturally adapted to make wildlife call such as these complicated calls by elk and other animals. In addition, animals and birds are instinctively wary and guarded. They generally avoid or flee from unusual sounds, smells and objects in their habitat. These realities create challenges for humans in these environments. Merely reading instructions or watching a video to train oneself in performing such calls can be inadequate to enable a user to learn to make such calls proficiently. Advantageously, the call trainer application 112 can implement sophisticated signal processing techniques that can evaluate the user's practice call in comparison with a master call and provide useful feedback to the user. As a result, the call trainer application 112 can help the user increase his or her proficiency with wildlife calls. The benefit of this interactive training can be that when applying calls in natural and outdoor settings, the user may improve the opportunity for the desired interaction with the wildlife he or she seeks. For hunters, this can include acquiring the active attention and movement of game animals they are pursuing and ultimately increased nearness to the animal. For other wildlife enthusiasts, such as bird watchers, photographers or other animal watchers, this can include obtaining visibility, proximity, and/or response of the animals or birds they would like to view or study.

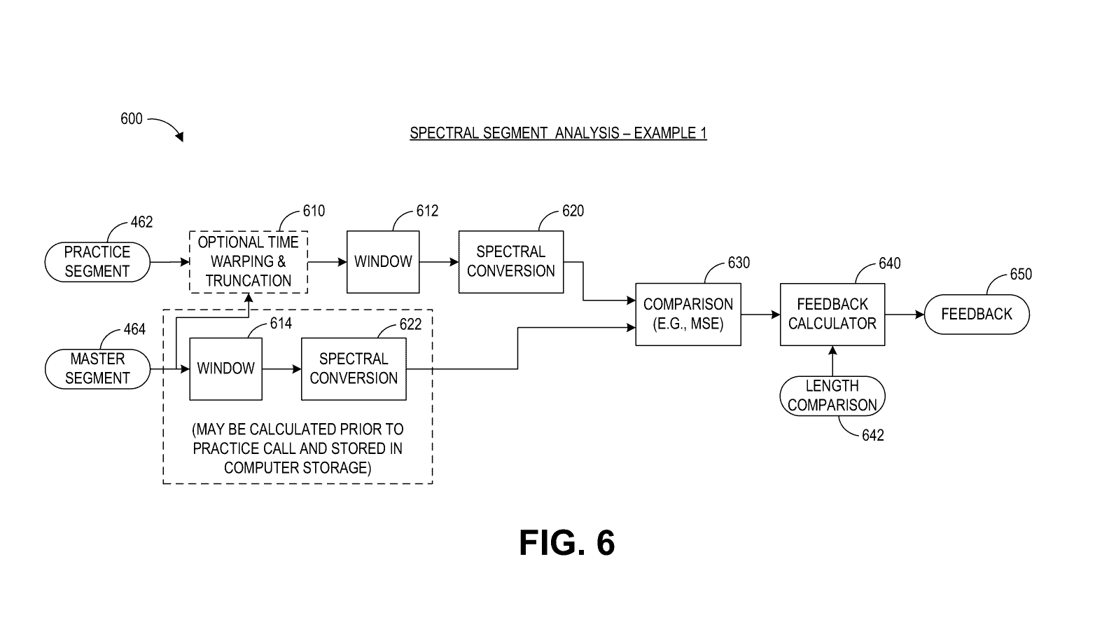

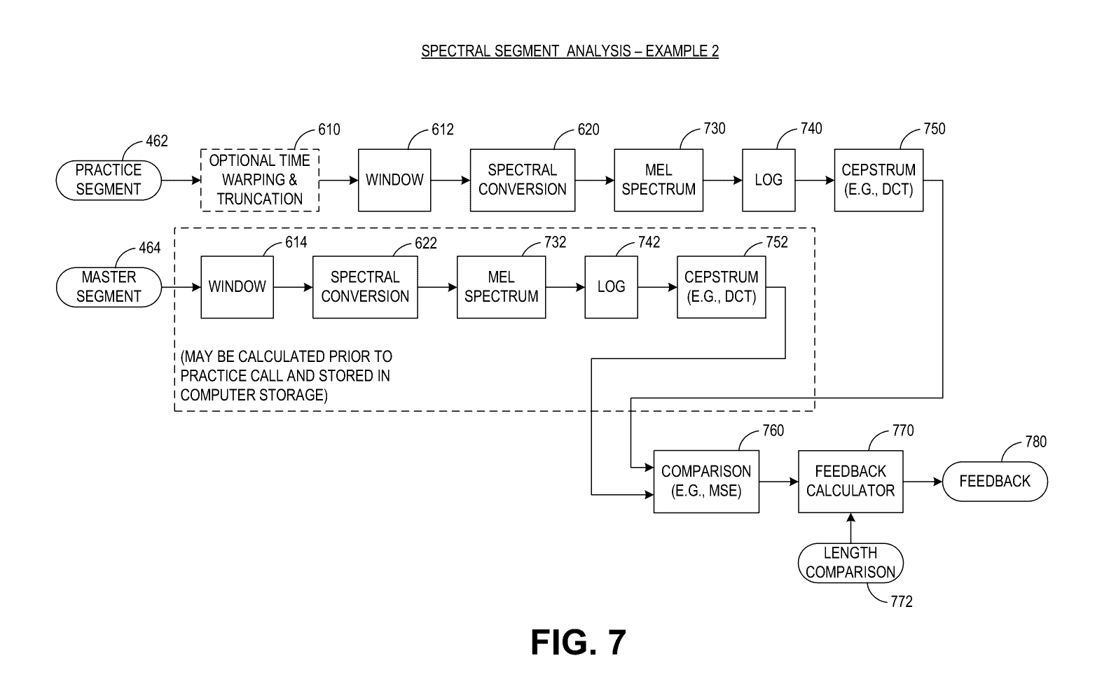

Following assessment, the call trainer application 112 may generate a feedback response that informs the user how he or she performed on the practice call in relation to the master call. The feedback can be quantitative, for example, in the form of a score, thumbs up or thumbs down indication, rating, or the like. In addition, the feedback may include qualitative feedback in addition to or instead of quantitative feedback. For instance, the feedback may include information on how the user performed in terms of various characteristics of the call such as volume, tone, pitch and rhythm, or any other sound or other characteristic associated with a particular animal's call, including, for example, feedback on any of the characteristics of calls described above. For example, the feedback might be in the form of qualitative feedback such as “the call needs to sound more terrified” (for a predator call) or “increase volume toward the end of the call and make the ending ‘CK’ sound in the ‘quack’ louder,” among other examples. Qualitative feedback can be combined with quantitative feedback by the call trainer application 112 as well. For instance, example feedback might state that “the ‘qua’ part of the quack received a 100% score, while the ‘CK’ part of the quack received a 75% score and should be made louder to improve performance.” Other quantitative and qualitative feedback examples are provided below with respect to FIGS. 6 and 7, among other FIGURES.

The user can evaluate the feedback received and then attempt additional practice calls using the call trainer application 112 if desired, each with its own new assessment against the master call. Through this interactive and iterative process, the user can gain competence and confidence in consistently making various wildlife calls.

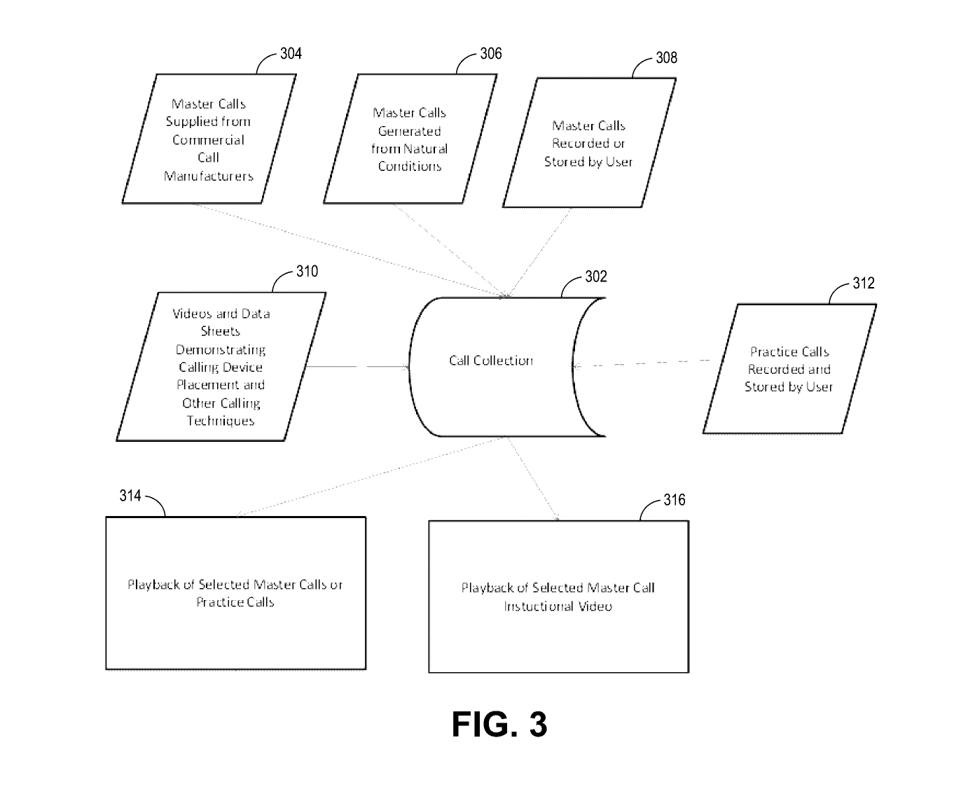

When initially setting up the call trainer application 112, in addition to installing the call trainer application 112, users can create an individual account with the wildlife call platform 130. Account creation can allow for the establishment of a user's server library with the wildlife call platform 130. The user server library can include a set of stored master calls on the remote wildlife call data store 130. Account creation can also allow the user to purchase master calls. Further, accounts facilitate administration and management of content of the remote wildlife call data store 130, maintenance of individual user practice calls in a call collection (see, e.g., FIG. 3), and/or other storage and archival features on the platform 130. An administrator user device or devices 120 (operated by an administrator or worker of an administrator of the platform 130) can access the wildlife call platform 130 to perform administrative maintenance, upload additional content (such as additional master calls), handle billing issues, and the like.

Within a user account with the platform 130, a user can catalog his or her practice calls, as well as track his or her training, progress and history. This tracking functionality can allow for comparing practice calls over a designated period of time against a specific master call (e.g., over a practice session or longer time period), sharing practice results with colleagues (e.g., via social networking content site or web site functionality), as well as reviewing overall competency with each type of call, and/or tracking changes in calling competency (progression or regression) over time.

A user's individual account can also allow for transfer and synchronization of his or her information to and from the server library or call collection in the remote wildlife call data store 132. Thus a user's calls, training session data, and the like, can be stored in a cloud storage device or database (e.g., the data store 132), which may be accessible by the call trainer application 112 over the network 108 from any computing device used by the user (e.g., on which the call trainer application 112 is installed or from a browser). Further, the call trainer application 112 can upload feedback it generates on a user's practice calls to the remote wildlife call data store 132 for remote storage (or cloud storage).

In other embodiments, the wildlife call platform 130 and remote wildlife call data store 132 are optional and may be omitted. Instead, the call trainer application 112, when downloaded, can include master calls that the user may practice against. Thus, the call trainer application 112 may be implemented entirely or almost entirely locally at the user device 110 once downloaded and installed in some embodiments.

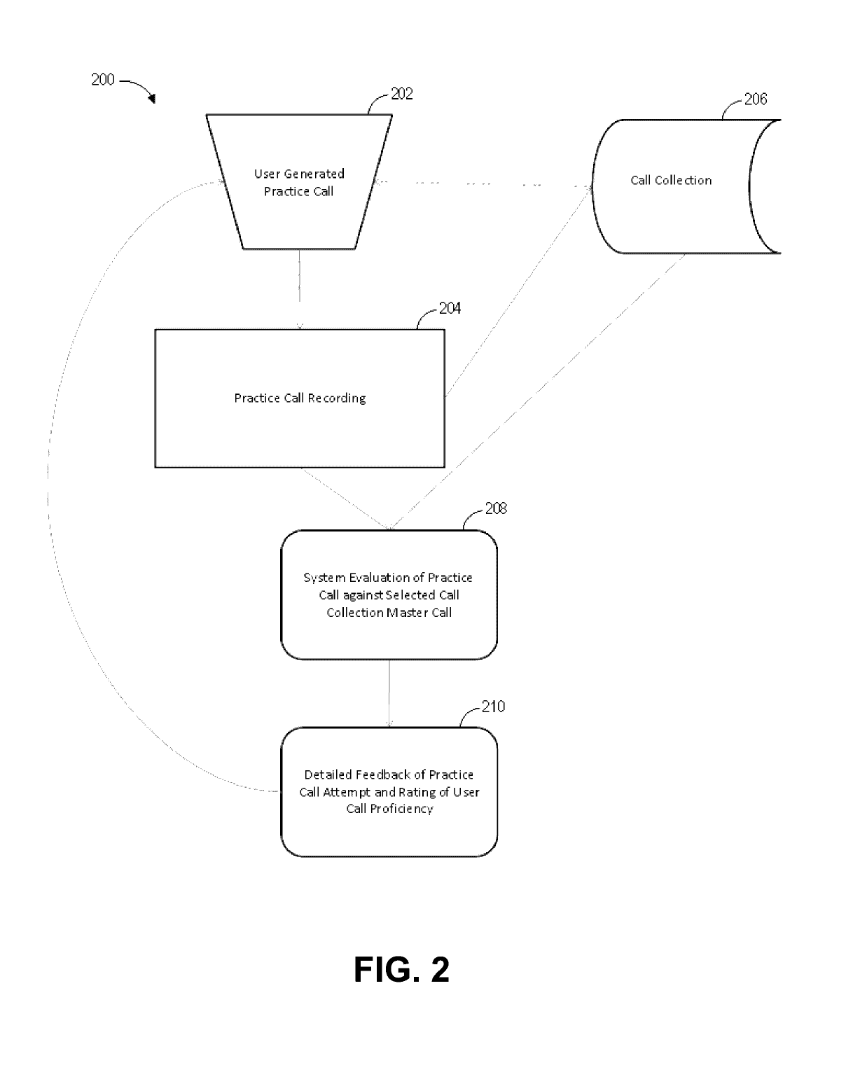

FIG. 2 depicts an example process 200 for programmatically training a user to make a wildlife call. The process 200 can be implemented by the interactive learning system 100 described above. For instance, the process 200 can be implemented by the call trainer application 112. However, it should be understood that the process 200 may instead be implemented by other types of computer systems or applications than those shown and described herein.

At block 202 of the process 200, a user generates a practice call. The user may generate the practice call by speaking or otherwise producing the call into a microphone of the user device 110. The call may be made with the user's voice, with the user's voice in combination with a calling instrument, or using a calling instrument that does not use the voice. Many calling instruments employ a user's voice to create a unique animal sound, an example of which is the duck call. An example of a calling instrument or call that does not employ the human voice is a deer can or bleat can, which may be turned by a user to simulate a deer call.

In addition to the example calls described above, the call trainer application 112 can train and evaluate users in any of the following types of calls, among others: For enthusiasts pursuing waterfowl such as ducks, there are a number of calls they may seek to master to be most effective in the field. These can include the basic quack call which should generally be a clean and crisp ‘quaCK’ as opposed to a ‘qua qua qua’ approach. The greeting call should be a series of five to seven notes in descending order at a steady even rhythm. When using a comeback call, the hunter is looking for an immediate response, which may be achieved through an urgent series of notes, performed fast and hard. Turkey calls have their own cadence and rhythm which should be mastered for greatest success. Clucks are used to reassure an approaching gobbler and can include one or more short staccato notes. Purrs are also reassuring calls, but can include softer, rolling sounds. Cutts can include loud clucks used to mimic excitement and lure dominant hens and trailing gobblers. The kee kee can include a three-note, two second call used to mimic young lost turkeys and reassemble a scattered flock. For bird watchers (birders), getting the attention of various birds can be done through pishing, which can include making small repetitive noises which can be raspy, higher pitched or sharp. Mimicking bird calls and whistles is a more difficult process to master and may be done by mouth or use of an instrument. With deer calls as a further example, the user can learn and practice the characteristics of non-aggressive calls such as grunts, bleats and bellows and aggressive calls such as sniffs, wheezes and rattling. Deeper pitched grunts mimic bucks versus does, with the deepest tones indicative of mature bucks. Bleats and bellows signal the breeding readiness of does while a short, aggressive rattling sequence may attract the dominant buck of the area. When training to call predator animals such as coyote, bobcat or fox, the user can learn to reproduce the cries of an injured or trapped cottontail or jackrabbit. The caller should attempt to impart feelings and intonations of terror, pain and despair to the screams generated by the call. The more terrified and frantic the call sounds, the greater the success may be.

The user-generated practice call may be recorded (block 204) and saved in the local and/or remote wildlife call data store(s) 114, 132 in any standard or proprietary audio format, such as a .wav file, .mp3 file, or the like. The call trainer application 112 can identify various aspects of the practice call including volume, tone, pitch and rhythm. The practice call can also be date and/or time stamped by the call trainer application 112. The user can also input personal notations relating to the practice call that may be saved or associated with the file. Such notations can be added, edited, or deleted at a later time as well.

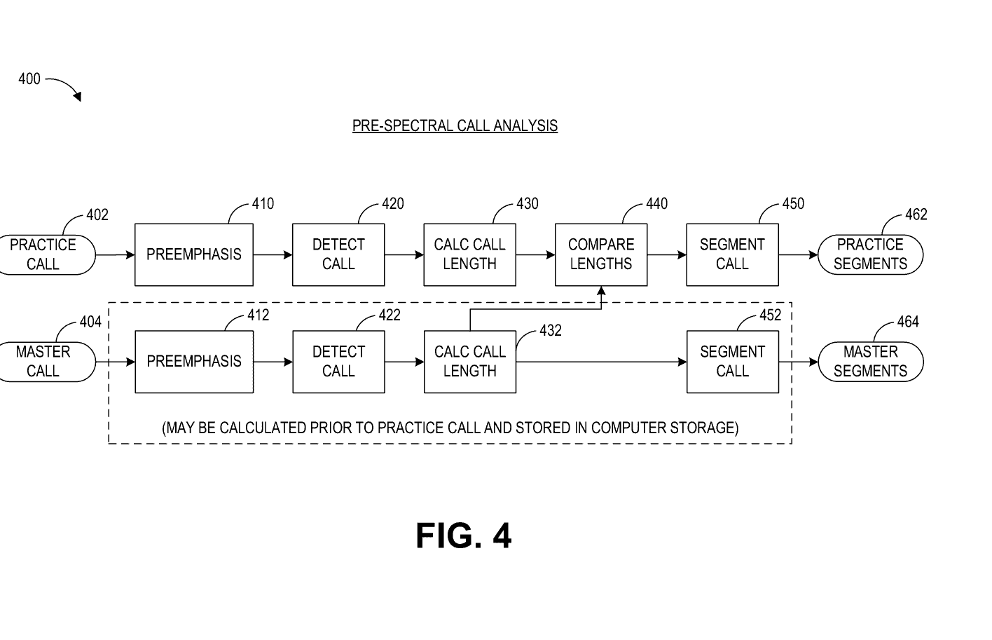

The call trainer application 112 may then process the practice call at block 208, comparing the aspects of the recorded call against those of a selected master call stored in a call collection 206 (which may be part of the local or remote data store 114 or 132). This processing may be done using sound recognition or matching techniques and algorithms, including signal processing algorithms. Such algorithms may be implemented in the time domain, frequency domain, or a combination of both. Example signal processing algorithms that may be used at block 208 are described in greater detail below with respect to FIGS. 4 through 7.

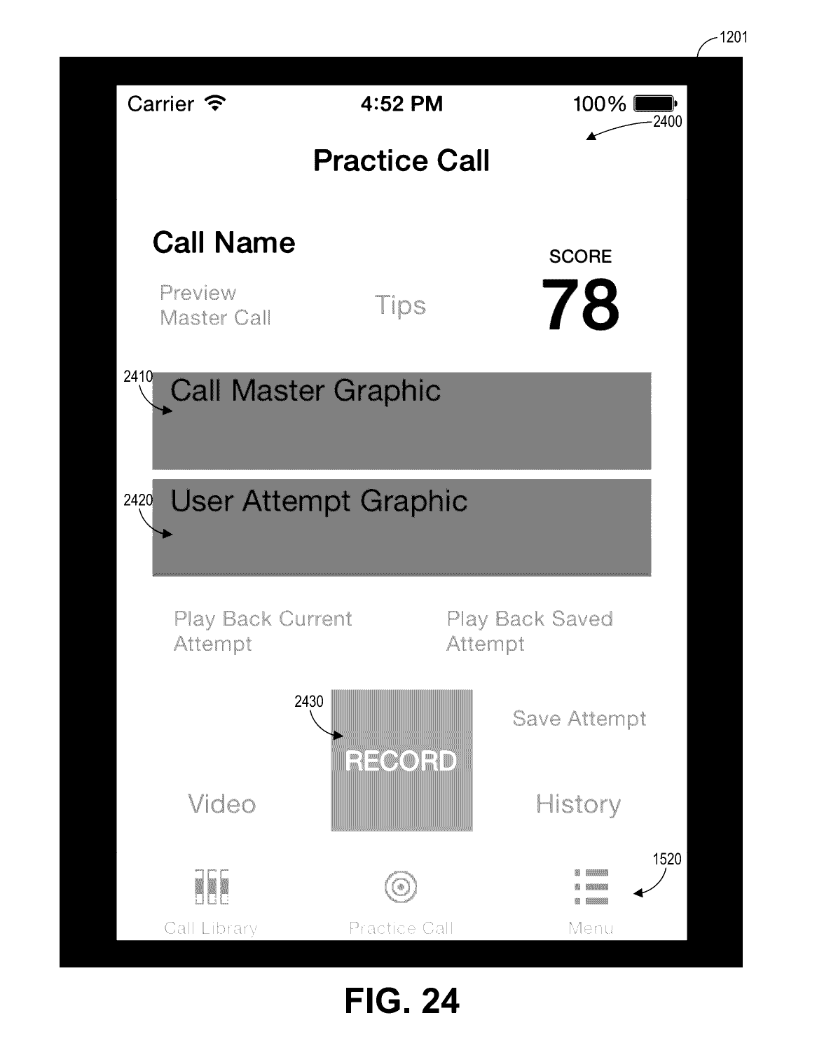

Following processing, the call trainer application 112 may provide feedback to the user at block 210 to illustrate how well the practice call matched the master call based on the processing in block 208. This feedback can include, for example, a graphical display of the master and practice calls (see, e.g., FIGS. 24 through 26) as well as a score or percentage proficiency rating of the practice call. A proficiency rating of 100% may indicate a perfect practice attempt in one embodiment, although other scales or scoring ranges may be used.

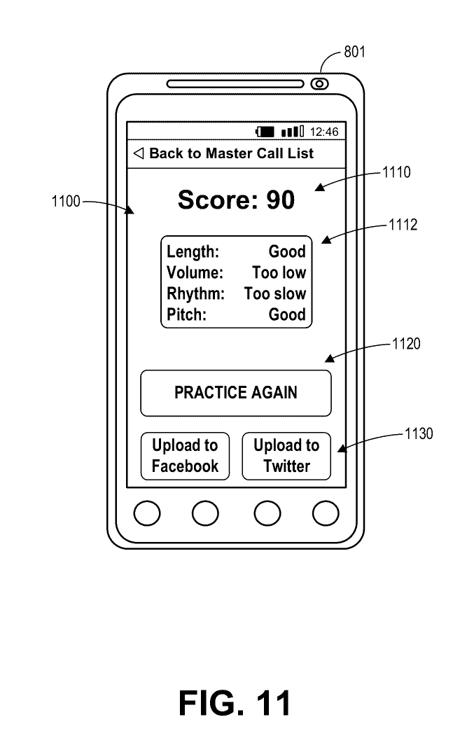

In addition, feedback other than a score or additional feedback in addition to the score may be provided by the call trainer application 112 (see FIG. 11). For example, this feedback can also include instruction on how to correct positioning of the calling device in the user's mouth or hand so as to perform a better call. This feedback may be responsive to a detected defect in the practice call. For instance, if a particular sound is detected as being poor, the system may know that a cause of the poor sound is due to a certain mispositioning of the call in the user's mouth, and the system can instruct the user to correct the positioning accordingly. Feedback can also include instruction to blow more slowly or quickly (change pace of blowing into a call), shake a call more slowly, or otherwise perform some action with respect to a mechanical calling device that would correct or attempt to correct a user's performance of a call.

Further, feedback may include segmenting the user's practice call into parts and providing individual feedback on each part, or parts where additional help is needed. A user may have performed well on the first few seconds of a long call, for instance, but may need assistance finishing the rest of the call, and feedback to that effect may be helpful for the user. Moreover, feedback can be in the form of audio (and/or video). For instance, feedback audio can include playing back a portion of the call that the user performed poorly, possibly followed by the user's rendition of that portion of the call, so that the user can focus on the aspect(s) of the call that can be improved upon. Additional feedback examples are described below.

If the user desires, the user can use the call trainer application 112 to replay the master call and/or the practice call to assist the user in identifying differences. Additionally, the call trainer application's 112 display can highlight specific areas where the practice call failed to match the master call in terms of volume, tone, pitch, and/or rhythm, among other attributes thereof.

The call trainer application 112 can also perform such comparisons and analysis on a cumulative basis using a selected number of previously stored practice call attempts (e.g., some or all attempts for an entire practice session) to help identify particular areas of alignment or disparity with the master call. The call trainer application 112 can overlay waveform images of one or more practice calls on top of each other along with the master call to highlight specific areas where the practice calls failed to match the master call in terms of volume, tone, pitch, rhythm, or other attributes thereof.

Following any of the above evaluations, the user can then reattempt the practice call, essentially repeating the process 200, with results stored and evaluated until the user ends the practice session. Some or all user practice calls can continue to be stored by the call trainer application 112 until actively tagged for deletion by the user.

Although the process 200 is described as being implemented by the call trainer application 112, at least some aspects of call trainer application 112 may instead be implemented by the wildlife call platform 130. For instance, the wildlife call platform 130 may perform the evaluation of the practice call against the master call at block 208 and/or generation of feedback at block 210. The wildlife call platform 130 may do one or more of these or other functions in an embodiment because the wildlife call platform 130 may be implemented on a server having more computing resources than the user device 110 that implements the call trainer application 112. Thus, the wildlife call platform 130 may optionally perform more processing-intensive functions at the request of the call trainer application 112 and provide results to the call trainer application 112 over the network 108 (see FIG. 1). As a result, more accurate and faster processing of practice calls may be performed in some embodiments.

FIG. 3 depicts an example call collection 302. Example features of the call collection 302 are shown as separate boxes 304 through 316 connected to the call collection 302, but these features should be understood to be included in the call collection 302. The call collection 302 is an example of the call collection 206 described above, and may be implemented in whole or in part in the local wildlife call data store 114 and/or the remote wildlife call data store 132.

Animals and birds utilize a number of calls for a variety of purposes in nature, and the call collection 302 can store variations of these different calls, instructional material for reproducing these calls, as well as recorded practice versions of these calls by one or more users. Typical animal calls include sounds for warning, locating, challenging, and mating. For example, it is believed that turkeys use over 26 calls in their vocabulary for these objectives. The call trainer application 112 can enable a user to train each of these calls (or a subset thereof), and in general, one call or even multiple calls per animal (possibly even using multiple different calling instruments), in addition to training multiple different animals' calls.

Contained in the call collection 302 can be master calls 304, 306, or 308 that have been purchased or otherwise obtained and stored from one or more sources for wildlife species that are of interest to the hunter or wildlife enthusiast. Master calls 304, 306, or 308 may be in the form of audio files that are downloaded or streamed to a user's device 110 or stored on storage media (e.g., data stores 114 or 132). For instance, in one embodiment, the call trainer application 112 builds the user's call collection of master calls through calls downloaded from files stored on the platform's 130 server library (e.g., in the data store 132). In addition, master calls can be uploaded to the call trainer application 112 from storage media such as CDs, DVDs, etc.

Sources for master calls 304, 306, or 308 in the call collection 302 can include call recordings (304) from commercial call manufacturers who develop and market calls to the consumer for specific purposes. Additionally, call recordings from actual wildlife (306) in their environment can be stored as master calls. Finally, master calls can be recorded (308) into the call collection by an instructor or another user (such as a user's friend) that is coaching a user in learning to make a call. Master calls in the call collection can be grouped, categorized and accessed in a number of ways, including by wildlife species, style of call, type of calling device, call manufacturer, etc. Within the call collection 302, a user can search the master calls and select a master call to listen to and train a practice call against. The master calls may be stored (in the data store 114 or 132) in the format of a database, flat file system, or the like.

Also included in the call collection 302 can be instructional videos 310 and/or data sheets including textual descriptions, techniques and purposes of various calls. These may be stored in the data store 114 or 132. The call collection 302 can also include other instructional information that complements the use of calls and aids the user when out in the field. This can include video or text describing camouflage techniques, smell or scent considerations, noise dampening methods, animal behavioral characteristics, or other tips that are applicable and directed to the wildlife they are pursuing. Instructional videos can be supplied by wildlife commercial call manufacturers, wildlife or hunting organizations or clubs, research groups or from other enthusiasts and may be purchased or otherwise accessed by user from within the call trainer application 112 or by accessing the platform 130 (e.g., with a web browser).

For instance, in the call collection 302, the user can access the instructional videos and data sheets (blocks 310, 312) that demonstrate use of a calling device, purposes for each call, concealment and other useful information. These videos and reference aids can assist the user in determining and practicing correct positioning of the calling device prior to attempting a practice call as well as proper cadence and repetition when calling. For example, correct placement of a voice call to the mouth, or a diaphragm within the mouth, may be shown. This is a common technique for elk calls such as “bugling”, deer calls such as “grunts” and duck calls such as “quacks” and “hails.” For calling devices operated by hand, those examples may be shown similarly. This can include box and friction calls to make turkey “clucks”, “yelps” and “purrs,” cans to make deer “bleats” and squeeze calls for simulating cow elk “mews” and “chirps.” The call trainer application 112 can play the videos directly for presentation to user or can output data sheets or other instructional material directly for presentation to the user.

Prior to using the call trainer application 112 or attempting a practice call, a user may log into his or her account and can select and listen to the master call through the system's platform speaker (block 314) to become familiar with the call and its various nuances. The selected master call may also be shown on the call trainer application's 112 display in a waveform to visibly detail aspects of the call such as volume, tone, pitch, and rhythm.

The call trainer application 112 can periodically back up or synchronize the call collection 302 with the wildlife call platform 130. This backup can include some or all master calls (whether acquired from the platform 130 or not), practice calls, or other user data. The user can establish the parameters as to frequency and comprehensiveness of this synchronization through administrative settings in the call trainer application 112 or call platform 130. Depending on the capabilities of the platform, the user may also be able to synchronize instructional videos and data sheets contained in the server library to the platform.

If the user device 110 is portable, the user can use the call trainer application 112 when traveling or out in the field. A user may thus practice a call with the call trainer application 112 in a real hunting or animal watching situation and not only receive feedback from the system itself, but may also gain the ability to compare and contrast that feedback with actual reaction from targeted animals that heard and responded (or did not respond) to the call. That said, the call trainer application 112 may include a warning to users to follow local hunting laws and regulations with respect to electronically playing back either master calls or practice calls in the field during a hunting situation.

If the user device 110 is not portable, or the use of an additional user device is desired, a user can access the wildlife call platform 130 (or an application store) to install the call trainer application 112 on, and transfer account and call collection 302 information to, another user device using a synchronization feature of the wildlife call platform 130. The user can then operate the call trainer application 112 on the new user device similar to operation on the initial user device, using information associated with his or her account. Similar to the initial user device, the call trainer application 112 can periodically back up or synchronize this additional user device with the wildlife call platform 130.

### III. Example Signal Processing Systems for Call Training

FIGS. 4 through 7 depict example processes 400-700 for comparing a practice call to a master call and generating feedback responsive to this comparison. Thus, these processes 400-700 depict more detailed embodiments of the processing of block 208 of FIG. 2. These processes 400-700 may be performed by hardware and/or software. For instance, the processes 400-700 may be implemented by the call trainer application 112 or the wildlife call platform 130. Although the processes 400-700 may be implemented by either the application 112 or platform 130, for ease of description, the processes will be described with respect to the call trainer application 112. It should be understood that the wildlife call platform 130 could perform any of the features described with respect to the call trainer application 112 in other embodiments.

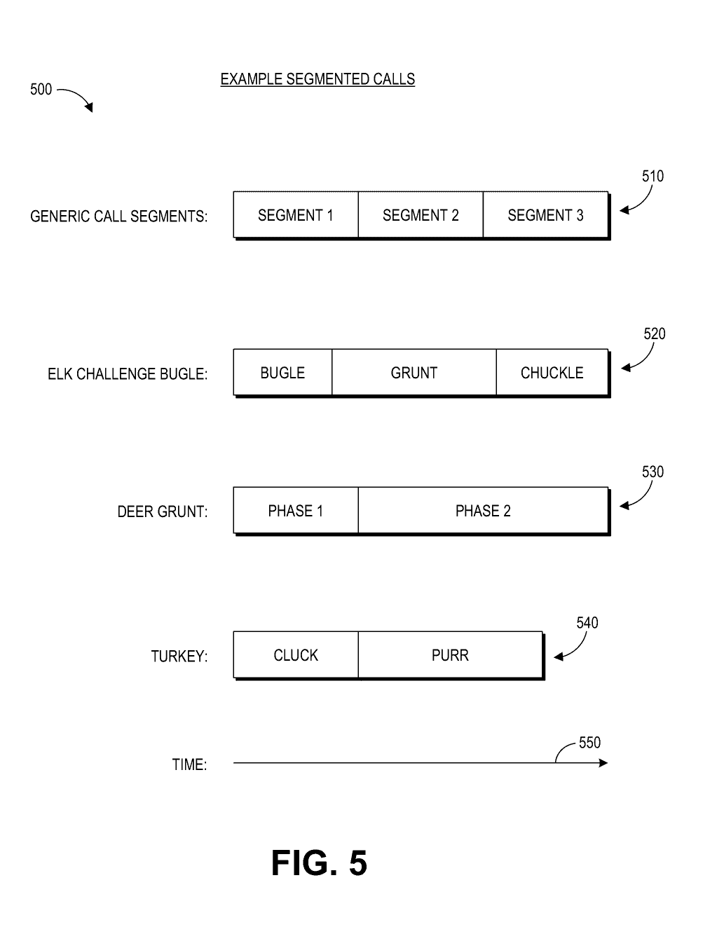

By way of overview, FIG. 4 depicts an embodiment of a process 400 for performing pre-spectral call analysis. The process 400 of FIG. 4 may be implemented as a preconditioning step to other more detailed processes 600 and 700 described with respect to FIGS. 6 and 7. The processes 600, 700 of FIGS. 6 and 7 represent example alternative processes that could be implemented after the process 400 of FIG. 4. Alternatively, both processes 600, 700 may be used together and their output compared or otherwise combined. FIG. 5 depicts example segmentations of calls that may be generated by the process 400 and processed further by the processes 600, 700.

Turning to FIG. 4, the process 400 begins by receiving a practice call 402 and a master call 404. The practice call 402 may be recorded by a user of the call trainer application 112, as described above. The call trainer application 112 can access the master call 404 from a user's call collection, such as any of the call collections described above, whether stored locally to the call trainer application 112 or remotely at the platform 130. The practice call 402 of the master call 404 be recorded at the same or different sample rates. For instance, the calls 402, 404 may be recorded at 48 kHz or some other sample rate.

Both calls are provided to pre-emphasis blocks 410, 412 respectively. Each preemphasis block 410, 412 can process the respective call through a filter that can emphasize higher frequencies. The filter may therefore be a high pass filter or the like. This high pass filter can increase energy of the signal at higher frequencies, which can better enable the call trainer application 112 to determine the beginning and end of the call. The cutoff frequency of the high pass filter may be variable and may depend on the particular master call being compared to by the practice call. For instance, a master call with relatively higher frequency content may result in a relatively higher cutoff frequency being selected for the high pass filter than a master call with relatively lower frequency content.

The output of the preemphasis blocks 410, 412 is provided to call detection blocks 420, 422. The call detection blocks 420, 422 can detect the start and end of each call in the recording. The practice call 402 may start after a small period of background noise or background silence that may be recorded before the user starts speaking the practice call 402. The end of the call may also include a brief period of background silence or noise. The master call 404 may or may not include background silence or noise at the beginning or end of the call. In an embodiment, the call detection blocks 420, 422 determine that a call has started at the point in time in which the energy in a sample of the call exceeds the background silence or noise by a predetermined threshold. The call detection blocks 420, 422 may, for instance, compare amplitudes of samples in a given call 402 or 404 with previous samples to determine whether the threshold has been exceeded. The end of the call can also be detected by the same way at blocks 420, 422.

Call length calculator blocks 430, 432 compute the length of each respective call 402, 404. The length can be represented as a number of samples (or sample blocks), a duration of time, or both. Call length values output by the call length calculators 430, 432 are provided to a length comparison block 440, which can compare the lengths of the two calls. If the length of the practice call matches the length of the master call, the call trainer application 112 can give a relatively higher score to the practice call than if the lengths do not match (see FIGS. 6, 7, and 11). The length comparison block 440 can determine that the call lengths match if the call lengths are within a predetermined margin of error.

The calls are segmented at block 450, 452 to produce practice segments 462 and master segments 464, respectively. In one embodiment, segmenting the calls can allow different segments of the practice call 402 to be compared to different segments of the master call 404. Further, each segment may be subdivided into frames or blocks of samples. The blocks of samples may include a number of samples that is a power of two to facilitate subsequent frequency domain processing, although this is not required in certain embodiments.

As shown, blocks 412, 422, 432, and 452 may be calculated prior to the practice call being recorded, and may be stored in computer storage, such as in either of the data stores 114, 132 described above with respect to FIG. 1. Computing this information beforehand can save processing resources of the call trainer application 112. For instance, these computations may be performed by the wildlife call platform 130 or the call trainer application 112 to produce the master segments 464. When a user downloads a master call 404 or otherwise accesses the master call 404 from the wildlife call platform 130, the master call 404 may be downloaded or the master segments 464 may be downloaded instead of or in addition to the master call 404 itself. Further, additional processing described below with respect to FIG. 6 or FIG. 7 (described below) can be performed by the platform 130 or the call trainer application 112 prior to downloading the master segments 464. Likewise, this additional processing may be performed by the call trainer application 112 prior to a user recording a practice call.

Turning to FIG. 5, example call segments 500 are shown. The call segments 500 are examples of how the practice segments 462 and master segments 464 may be generated. Example segments 510 show how any call can be segmented into multiple different segments. Three equal-length segments 510 are shown as one example way to segment a call. Thus for instance, a practice call may be segmented into three segments, and a master call may be segmented into three segments having the same length as the practice call segments. The call trainer application 112 can then compare the first segment of the practice call with the first segment of the master call, then compare the second segment of the practice call with the second segment of the master call, and so on. Although three segments are described herein as one example embodiment, a practice call may be divided into any number of segments.

Dividing a call into segments can allow related aspects of a call to be compared together. Since different calls may have very different segments, it can be useful to evaluate which segments of the call a user performs well and which segments of a call the user does not perform as well. A few example animal calls are shown in FIG. 5. For instance, segments 520 of an elk challenge bugle are shown including three separate portions, a bugle, a grunt, and a chuckle. Although not shown, each of these segments may be sub-segmented into further segments based on features of each individual segment. The user practicing an elk challenge bugle call may perform well with one or more of the three segments 520 of this call while performing poorly with the others. By comparing the practice call with a master elk challenge bugle call, the call trainer application 112 can provide feedback on those segments (or subsegments) of the elk challenge bugle call that the user is having difficulty with. Similarly, a deer grunt call is shown with two segments 530, labeled phase 1 and phase 2, indicating that the deer grunt can have two distinct phases that sound different and may be evaluated differently. Likewise, one type of turkey call may have two segments 540, namely a cluck and a purr. A time axis 550 showed indicate how the segments may progress over time in any given call (e.g., segment 1 is followed by segment 2, which is followed by segment 3, etc.).

Although the call trainer application 112 can evaluate practice calls by segmenting them, this is not required and calls may instead be evaluated as a whole. Further, even if the call trainer application 112 evaluates practice calls based on segments, the call trainer application 112 may still give feedback on the practice call as a whole. Thus, the processing described with respect to FIGS. 4, 6, and 7 may be implemented on an entire practice call instead of segments thereof.

FIG. 6 depicts an embodiment of a process 600 for performing spectral segment analysis. The process 600 can compare the practice segment 462 with the master segment 464 generated in FIG. 4. Although not shown, the process 600 may be performed for each segment in the practice call and the master call. Thus, once each of the segments of the practice call and master call have been compared, the process 600 may be completed.

The practice segment 462 and the master segment 464 may be supplied to an optional time warping and truncation block 610 as shown. Time warping may be used at block 610 to match samples in the two segments 462, 464, for example, if the two segments 462, 464 were recorded at different sample rates. If the segments 462, 464 were recorded at the same sample rate, or in other embodiments, block 610 may be omitted. Block 610 may use current, publicly available time warping algorithms to match the samples of the different segments 462, 464. Block 610 can also perform truncation of the practice segment 462 and/or master segment 464 to cause the two segments 462, 464 to have the same or approximately same length and therefore be easier to compare one against another.

Whether time warping is performed or not, in an embodiment, samples or sample blocks (described above with respect to FIG. 4) can be provided to window functions 612, 614 (respectively). The window functions 612, 614 can prepare the segments 462, 464 for spectral processing. Any window function 612, 614 may be used, including a rectangular window, Hamming window, or Hanning window, to name a few examples. The output of the window functions 612, 614, are provided to spectral conversion blocks 620, 622. The spectral conversion blocks 620, 622 can perform spectral conversion on the input samples or sample blocks provided by the windows 612, 614. For example, the spectral conversion blocks 620, 622 can perform a Fourier transform, discrete Fourier transform, fast Fourier transform (FFT), or another mathematical transform on the input samples to convert those samples from the time domain to the frequency or spectral domain. The spectral conversion performed may create a magnitude spectrum, the phase spectrum, a power spectrum, an energy spectral density, a power spectral density, combinations of the same, or the like. For convenience, this application refers to any of these conversions as spectra (or spectrum in the singular). Thus, the term “spectrum,” in addition to having its ordinary meaning, can refer to magnitude spectrum, the phase spectrum, a power spectrum, energy spectral density, or power spectral density, combinations of the same, or the like, among other spectral computations, sets, or quantities.

As described above with respect to FIG. 4, certain blocks, such as block 614 and 622, may be computed on the master segment 464 prior to recording of practice call and stored in computer storage. For instance, these blocks may be computed by the wildlife call platform 130 prior to downloading the master segments 464 to the call trainer application 112, or alternatively, may be computed by the call trainer application 112 itself.

The outputs of the spectral conversion blocks 620, 622 are provided to a comparison block 630. The comparison block 630 can compare the spectrums of the practice and master segments 462, 464 (or sample blocks thereof, e.g., on a block-by-block basis). The comparison may be a comparison of one or more different characteristics of the two different spectra. For instance, the comparison block 630 can compare magnitudes of the two spectra. If the difference between magnitudes of the two spectra is small, then the practice segment 462 is likely close to the master segment 464. One technique for comparing magnitudes of the two spectra is the mean squared error method. The following equation (1) is an example formula that may be used to compute the mean square error:

$$MSE = \frac{1}{n} {\sum }_{i = 1}^{n} {( {x}_{i} - a )}^{2} \qquad ( 1 )$$

where xᵢ represent a spectral value (such as an FFT bin value) from the practice segment 462 and a represents a spectral value (such as an FFT bin value) from the master segment for 64 (or vice versa), and where n is an integer that represents the number of spectral values (such as the total number of FFT bin values). If the spectral conversion at block 620, 622 is computed using the FFT, for example, each spectral value at each FFT bin from the practice segment 462 can be compared with a spectral value at an FFT bin corresponding infrequency from the master segment 464. The spectral values for each segment 462, 464 may each be represented as an array of values, in which case, the mean square error (MSE) can be computed by comparing values at the same indices of the two arrays.

In one embodiment, if the result of the mean square error computation is below a predetermined threshold, the call trainer application 112 may consider the practice segment 462 to match the master segment 464. The output of the comparison block 630 is provided to the feedback calculator 640. The comparison block 630 may output a value that represents the mean square error to the feedback calculator 640, or the comparison block 630 may output an indicator of value that represents whether the mean square error was below the predetermined threshold. The feedback calculator 640 can use this information, possibly together with other information, to compute or score or otherwise provide feedback 650 for the call trainer application 112 to output to a user. The feedback calculator 640 may, for instance, compute a score that is based on the mean square error value, which may be the mean square error value or a value selected from a lookup table based on the mean square error value, or the like. The score may be mapped to a scale such as a 0 to 100 scale, with 100 being a top score and 0 being a low score, although other scoring scales may be used.

The feedback calculator 640 may also take other factors into account when computing the feedback 650. For instance, the feedback calculator 640 can receive the length comparison 642 calculated with respect to block 440 of FIG. 4. The feedback calculator 640 can determine that if the length comparison indicates a larger difference in length between the practice and master calls, that the score should be lower and if the length comparison indicates a smaller difference, that the score should be higher. The feedback calculator 640 can combine its analysis of the length comparison 642 with its analysis of the output of the comparison block 630, such as the mean square error value or its comparison with a threshold. The feedback calculator 640 can also output an indication of the length match or mismatch as a separate score or indicator (see, e.g., FIG. 11).

The feedback calculator 640 may also perform other analysis and resulting feedback on the spectral content output by the conversion block 620, 622. This feedback may be generated with or without performing the comparison at block 630 and/or length comparison 642. For instance, the feedback calculator 640 can look at various attributes or aspects of the practice call segment 462 as compared to the master call segment 464. These attributes can include volume, rhythm, length, pitch, or other aspects of the different segments. These attributes may be analyzed in the frequency domain and/or in the time domain. The feedback calculator 640 can provide feedback on any of these attributes instead of or in addition to providing a score to the user. The feedback 650 provided by the feedback calculator 640 can be output on a user interface or display of the user device, which user interface may be generated by the call trainer application 112 and/or by the wildlife call platform 130. Further, as described above, feedback based on the segment attributes may be computed by the feedback calculator 640 based on the entirety of the practice call and master call instead of or in addition to being based on segments.

As one example, in the time domain, the feedback calculator 640 can receive the segments 462, 464 and compare the (normalized) volume between the two segments. This volume comparison can include identifying a normalized volume of each segment by identifying the highest amplitude sample and the lowest amplitude sample in each segment, computing a difference between the highest and lowest amplitude samples for each segment (to compute normalized volume), and then comparing this difference (in the practice call and master call) in normalized volume between segments. A greater difference may indicate that the difference in volume between the practice and master segments is significant, whereas a smaller difference may indicate that the user's practice call segment had a desired volume to match the master call segment.

In some embodiments, some attributes that feedback may be provided on may be relevant to some types of animal calls and not others. The feedback calculator 640 can provide specific feedback that is particular for the master call selected by the user to practice against (see, e.g., FIG. 5).

The feedback provided by the feedback calculator 640 may also be qualitative in addition to or instead of quantitative. For instance, if an elk challenge bugle call 520 is being analyzed, the feedback calculator 640 may identify that the user's practice call did well matching the bugle segment, poorly matching the grunt segment, and well matching the chuckle segment (see FIG. 5). Although the feedback calculator may determine this quantitatively, the feedback calculator 640 may output an indication on the user interface of the call trainer application that indicates that a user may want to practice the grunt segment, or that the grunt was “fair,” or the like. Visually, this may be accomplished by the call trainer application 112 in a variety of ways, such as by outputting a visual thumbs-up or thumbs down for each segment or for the call generally, or by providing text (see FIG. 11) or even colors that represents “good,” “fair,” or “poor,” such as green, red, yellow (respectively), or the like. Feedback can also include outputting specific tips for reproducing the call or specific tips for segment(s) of the call that received a low score. Many other variations are possible.

As may be expected, the comparisons of practice and master calls as well as the feedback generated may be more complex than simple voice detection algorithms used in language training algorithms, given that animal calls may have multiple different segments that may be very different from each other. Further, rhythm, pitch, amplitude, and the like may be more important in creating accurate animal calls that will attract, rather than scare away, animals, as compared with human speech and language training that may have a wider margin for error to reach a match.

FIG. 7 depicts another embodiment of a process 700 for performing spectral segment analysis. Like the process 600 of FIG. 6, the process 700 can compare the practice segment 462 with the master segment 464 generated in FIG. 4. The process 700 is an alternative implementation of the process 600, although the processes 600 and 700 may both be implemented together in an embodiment and their results compared to develop feedback and/or scoring of a practice call. Although not shown, the process 700 may be performed for each segment in the practice call and the master call. Thus, once each of the segments of the practice and master call have been compared, the process 700 may be completed.

The process 700 includes several components of the process 600, including blocks 610 through 622. These components may have the same or similar functionality as described above with respect FIG. 6. The difference between the process 600 and the process 700 is that in the process 600, a spectral comparison is performed based on the output of the spectral conversion block 620, 622, whereas the process 700 computes additional spectral characteristics or transformations prior to performing comparison between call segments 462, 464. These additional transformations may be referred to computing mel-frequency cepstral coefficients (MFCC) or performing mel spectral analysis.

For instance, at mel spectrum blocks 730 and 732, the outputs of spectral conversion block 620, 622 are transformed into the mel spectral domain by applying a mel filter bank to each spectral output of blocks 620, 622. Each filter in the filter bank may have a magnitude frequency response that is triangular in shape (or the like), for example, that may be equal to unity at the center frequency and decrease linearly to zero at the center frequency of two adjacent filters. Each of the filter outputs in the filter bank can be the sum of its filtered spectral components, for example, as follows:

F(Mel)=[2095*Log 10(1+f/700) (2)

where F(Mel) represents a mel frequency in the mel spectrum, and f represents a frequency in the spectrum output by the spectral conversion block 620 or 622. A log block 740, 742 may then be applied to the output of each mel spectrum block 730, 732 to take the logs (natural or otherwise) of the powers of each of the mel frequencies. The resulting mel spectrum may include a lower dimension than the spectrum output by block 620, 622. An example dimension of a mel spectral array for a 100 ms time sampling may be 12 items. Converting to the mel domain can result in analysis being performed on the segments 462, 464 that models the way our ears interpret sound frequencies, as her ears may act as a filter banks having characteristics similar to the magnitude frequency response of the mel filter banks.

The output of the log blocks 740, 742 is provided to cepstrum block 750, 752. Each cepstrum block 750, 752 can compute a cepstrum of the (log) mel spectrum. Essentially, the cepstrum blocks 750, 752 can treat the mel spectrum as if it were a signal to compute a spectrum of a spectrum. The cepstrum blocks 750, 732 may compute the cepstrum using any suitable mathematical transform, such as the discrete cosine transform or DCT, the FFT, or other transforms described above. The cepstrum computed by each block 750, 752 may be useful because the bins of the mel filters 730, 732 can be highly correlated with one another, and the DCT or other spectral transform can decorrelate these bins so that they may be more accurately compared between the two segments 462, 464.

The outputs of the cepstrum block 750, 752 are provided to comparison block 760. The comparison block 760 may perform any of the features or comparisons described above with respect to the comparison block 630 of FIG. 6, including the mean square error comparison. The output of the comparison block 760 is provided to the feedback calculator 770, which can perform any of the feedback described above with respect to the feedback calculator 640 of FIG. 6 to produce feedback 780, including based on a length comparison 772 derived from the length calculation of FIG. 4. The feedback may, for instance be qualitative as well as or instead of quantitative. The feedback may also be based on time domain analysis or other frequency domain analysis. In an embodiment, the attributes of the segments may include the attributes described above with respect to FIG. 6 and may be calculated in the same or in a different fashion. The volume difference, for instance, may be computed by comparing magnitudes of the mel frequencies of the two spectrums, which may be more accurate than the time domain comparison described above (or even represent loudness rather than just volume). Similarly, the volume difference may be computed in the frequency domain based on the spectra output by the spectral conversion blocks 620, 622.

### IV. Example User Interfaces

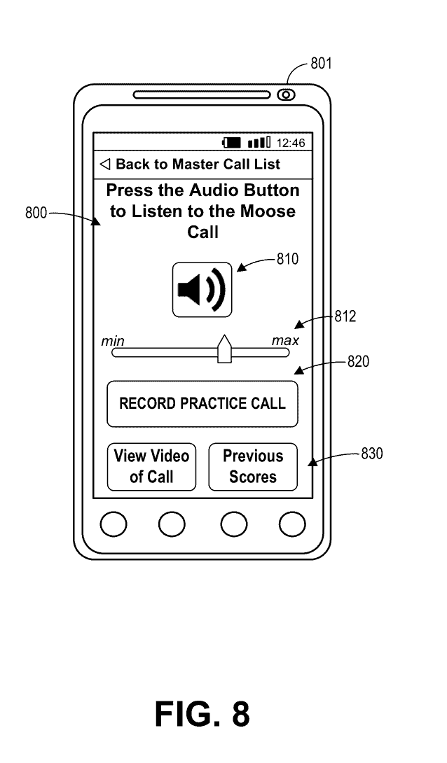

FIGS. 8 through 29 depict example mobile device user interfaces that can implement a variety of the features described herein. These user interfaces include features for enabling users to train practice calls, purchase master calls, maintain a call collection, and the like. In general, the user interface is shown or described with respect FIGS. 8 through 29 can provide any of the user interface functionality described above or elsewhere herein.

Each of the user interfaces shown includes one or more user interface controls that can be selected by a user, for example, using a browser or other application software. Thus, each of the user interfaces shown may be output for presentation by the call trainer application 112, which may optionally include a browser or any other application software. The user interface controls shown are merely illustrative examples and can be varied in other embodiments. For instance, buttons, dropdown boxes, select boxes, text boxes, check boxes, slider controls, and other user interface controls shown may be substituted with other types of user interface controls that provide the same or similar functionality. Further, user interface controls may be combined or divided into other sets of user interface controls such that similar functionality or the same functionality may be provided with very different looking user interfaces. Moreover, each of the user interface controls may be selected by a user using one or more input options, such as a mouse, touch screen input, game controller, or keyboard input, among other user interface input options. Although each of these user interfaces are shown implemented in a mobile device, the user interfaces or similar user interfaces can be output by any computing device, examples of which are described above. The user interfaces described herein may be generated electronically by the call trainer application 112 or the wildlife call platform 130 described above.

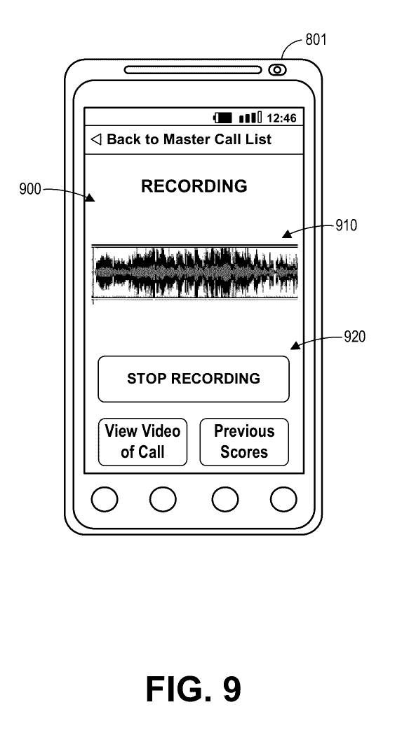

FIGS. 8 through 11 depict example user devices 801 that are examples of the user device 110 of FIG. 1, each user device 801 depicting a user interface 800-1100. In particular, FIG. 8 depicts a user interface 800 that provides functionality for a user to listen to a wildlife call by pressing a button 810. When the call trainer application 112 plays back a master call, the application 112 can optionally output a graphical presentation of a waveform of the master call. A volume control 812 is also provided, as well as a button 820 for recording a practice call and buttons 830 for viewing a video of the call and viewing previous practice scores associated with a user for that particular call. User selection of the “record practice call” button 820 can cause a user interface such as the user interface 900 shown in FIG. 9 to be displayed. The user interface 920 of FIG. 9 indicates that recording has started, prompting a user to audibly produce a wildlife call into a microphone of the mobile device. The user interface 900 also outputs a waveform 910 of the practice call as it is being recorded to show the user some visual indication of the recording being performed. The user may select about 920 to stop the recording. As described in greater detail below, the master call waveform may also be shown on top of, next to, or otherwise in proximity to the practice call waveform 910 in some embodiments.

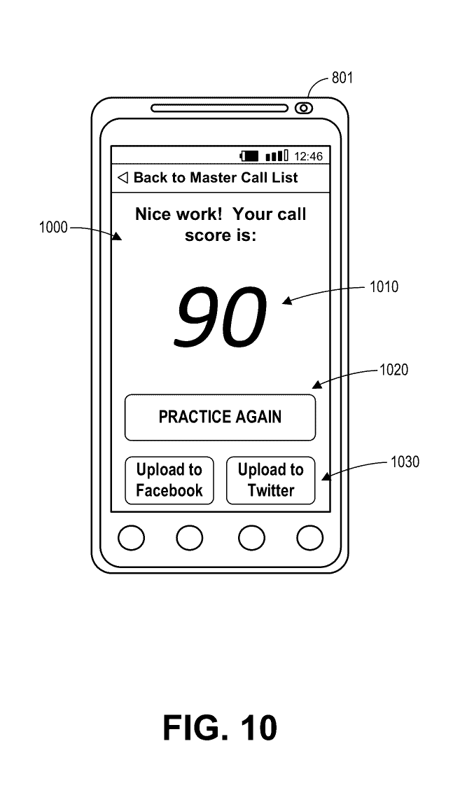

Upon selection of a “stop recording” button 920, the call trainer application 112 (or platform 130) can analyze the user's recorded call and provide feedback to the user using any of the features described above. Alternatively, the call trainer application 112 can stop recording when it detects that the user has stopped making the call. For instance, the call trainer application 112 can output a score or rating 1010 such as is shown in a user interface 1000 of FIG. 10, among possibly other feedback described above (see, e.g., FIG. 11). FIG. 10 also provides a button 1020 that provide functionality for a user to practice the call again and buttons 1030 for uploading the score (or other feedback not shown) to social media sites such as Facebook™ and Twitter™. FIG. 11 depicts another example user interface 1100 that is an alternative version of the user interface 1000. The user interface 1100 outputs a score of 1110 as well as feedback 1112 are more particular attributes of the users practice call, such as the length, volume, rhythm, in pitch (described above, see e.g., FIGS. 4 through 7). A button 1120 is provided to practice again, and buttons 1130 are provided to upload the results to example social media sites. Although not shown, the feedback output by the call trainer application 112 may include a visual comparison of a master call waveform with the practice call waveform. This visual comparison may include a highlighting of areas where the calls did not match or substantially match, or where any characteristic thereof did not match (e.g., within a threshold).

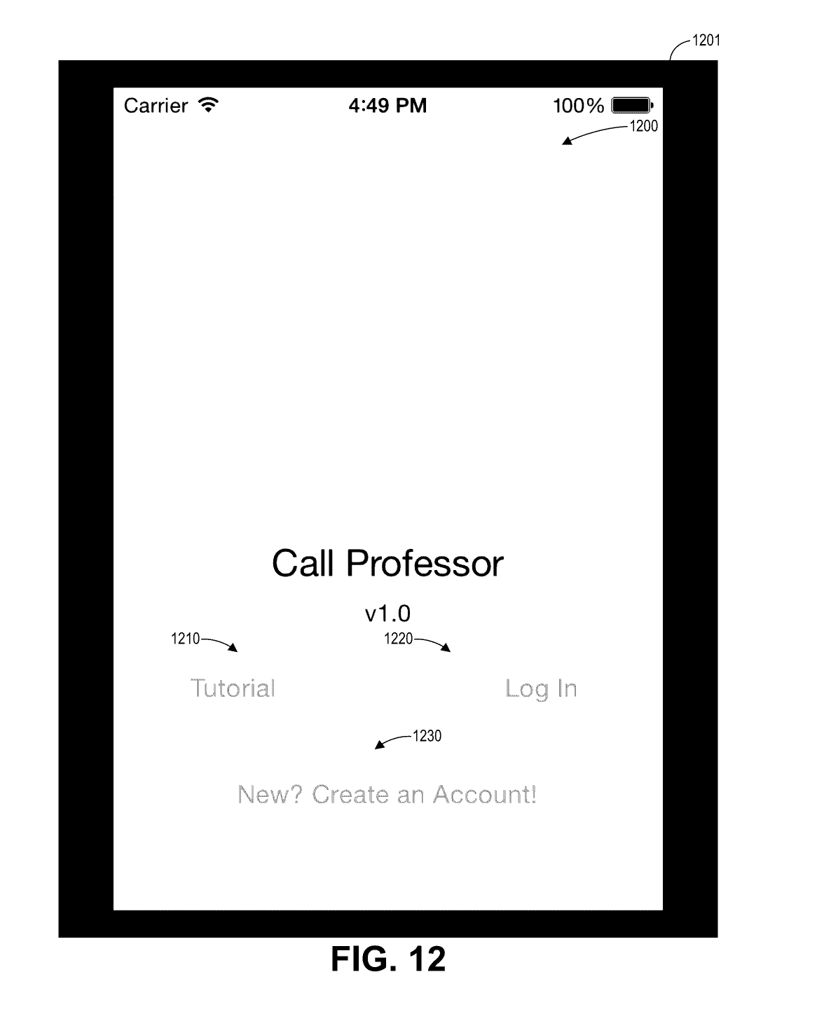

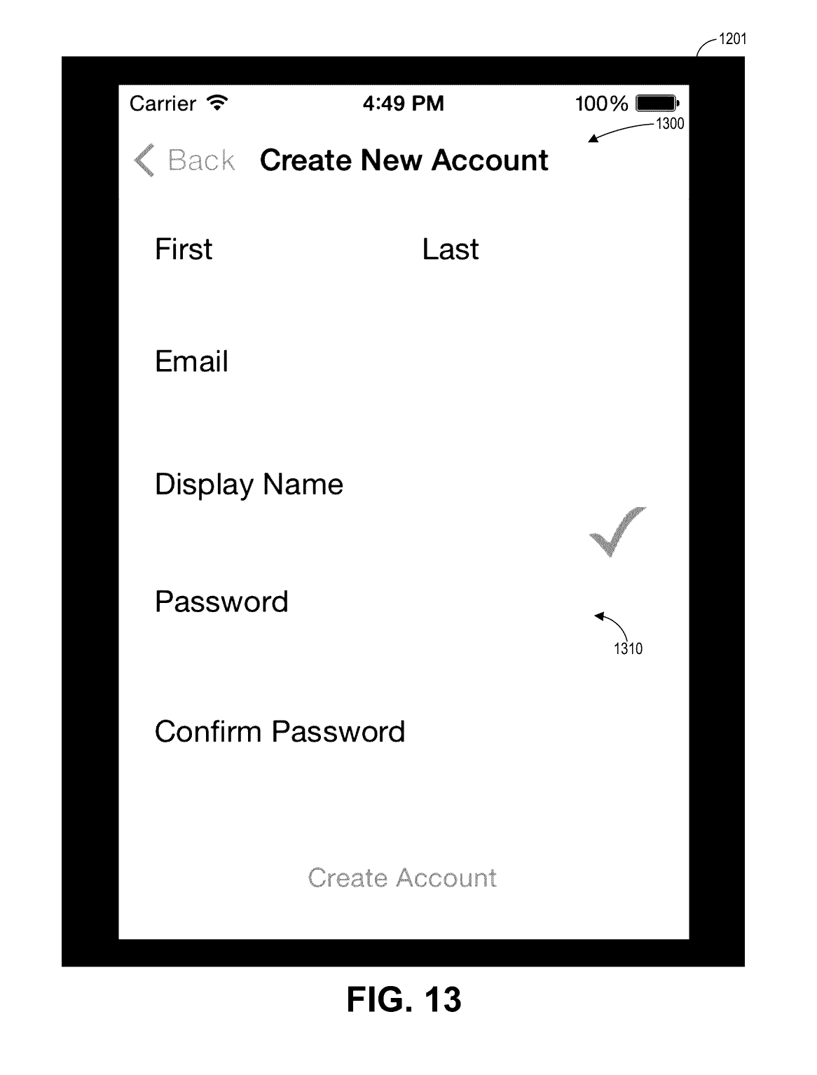

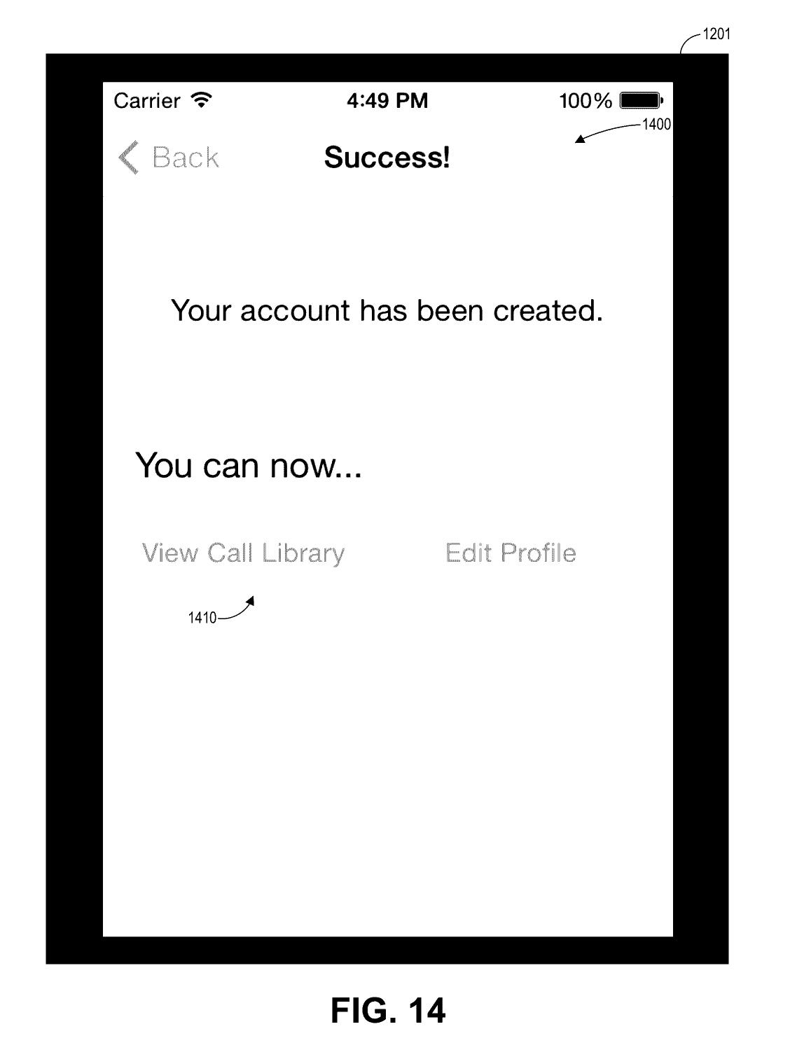

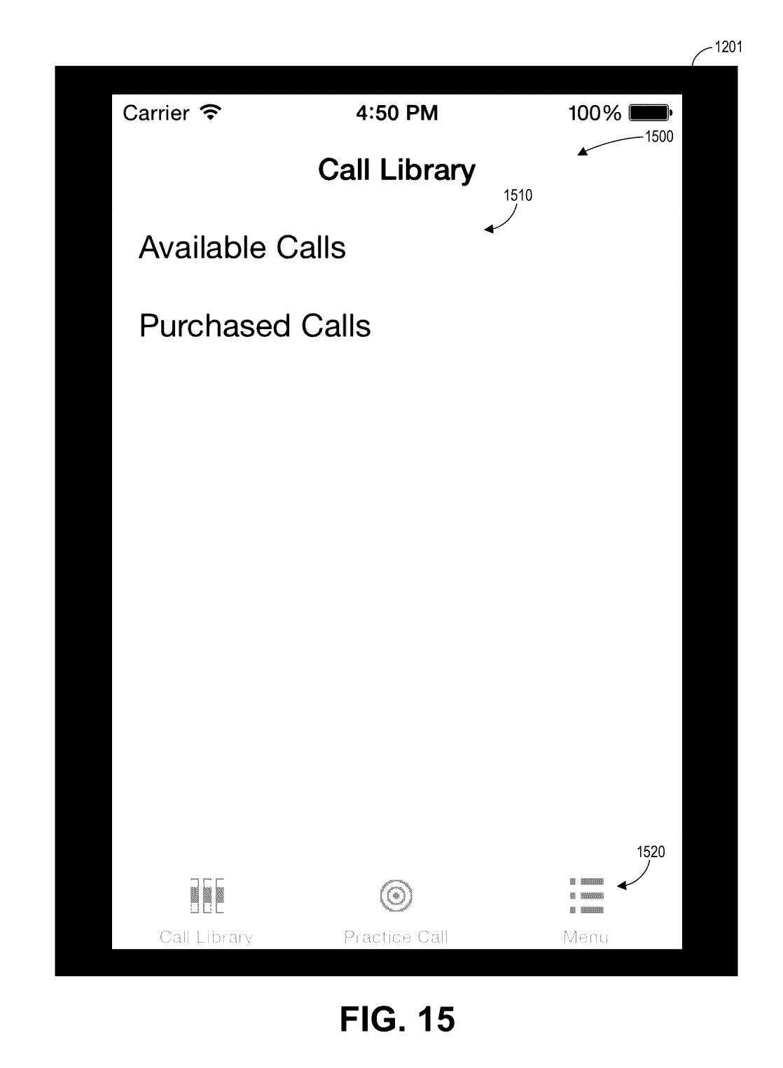

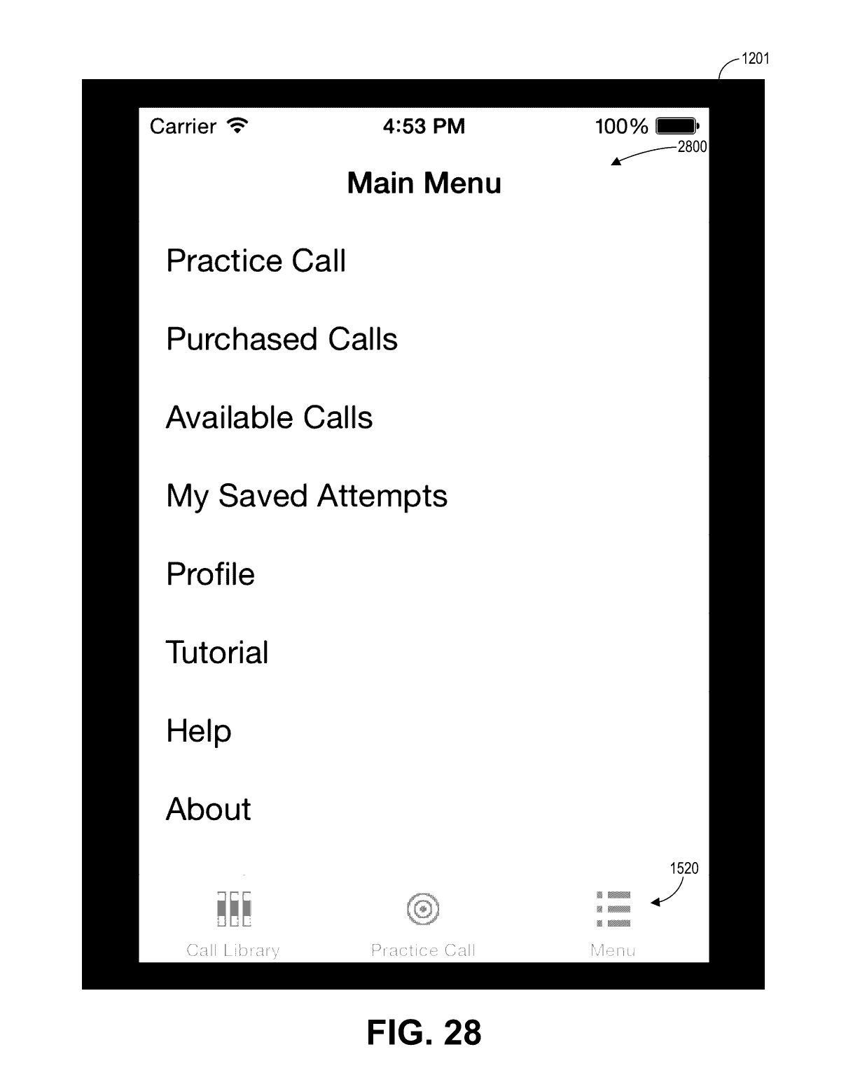

FIGS. 12 through 29 depict additional example user interfaces implemented in another user device 1201 that is an example of the user device 110 of FIG. 1. FIG. 12 depicts the user interface 1200 that represents main start screen of a call trainer application 112 referred to as “Call Professor.” The user interface 1200 includes a button 1210 to access a tutorial, a button 1220 to login to a user's account, and a button 1230 to create a new account. Selection of the button 1230 can cause a user interface 1300 to be output in FIG. 13, which includes fields 1310 for creating an account. Upon successful creation of account, a user interface such as the user interface 1400 FIG. 14 may be shown. Buttons 1410 are provided in the user interface 1400 for viewing the user's call library or call collection (which may be empty upon account creation or have certain default master calls included) and for editing a user's profile. FIG. 15 depicts a user interface 1500 that presents a user's call library or call collection so that the user may select menu items 1510 to access calls available to purchase or download and previously purchased calls. Menu buttons 1520 in user interface 1500 and in the remaining user interfaces allow user to quickly access the call library, practice a call, or access a main menu (see FIG. 28).

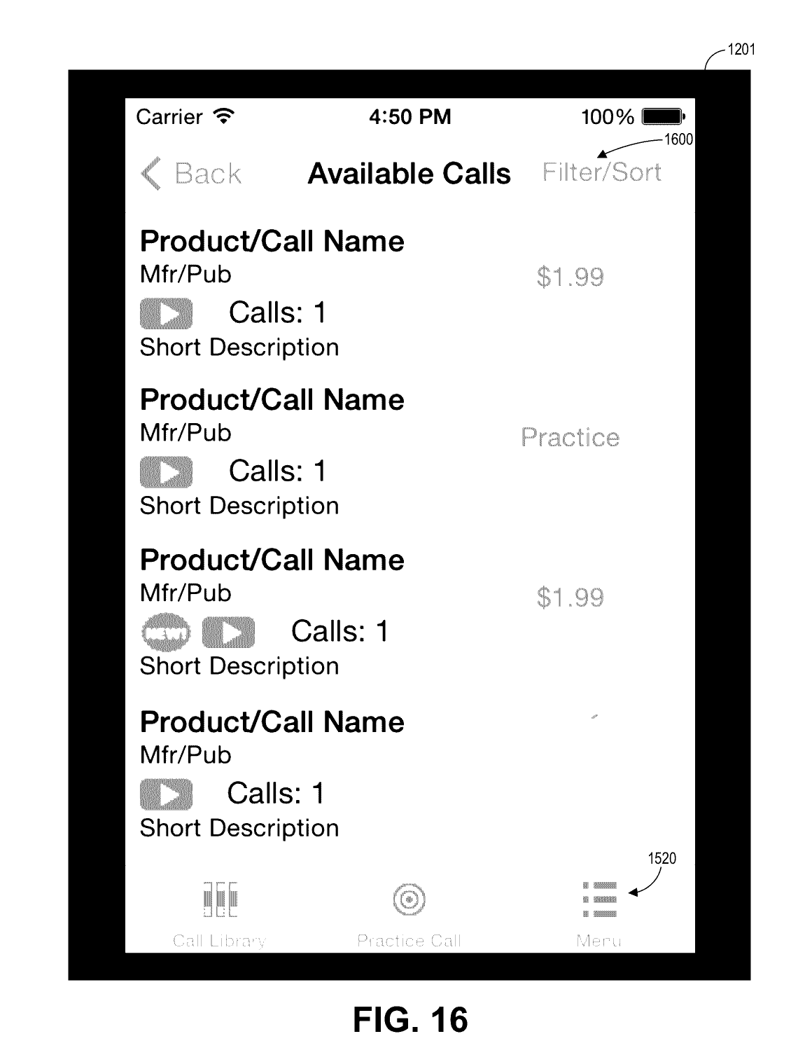

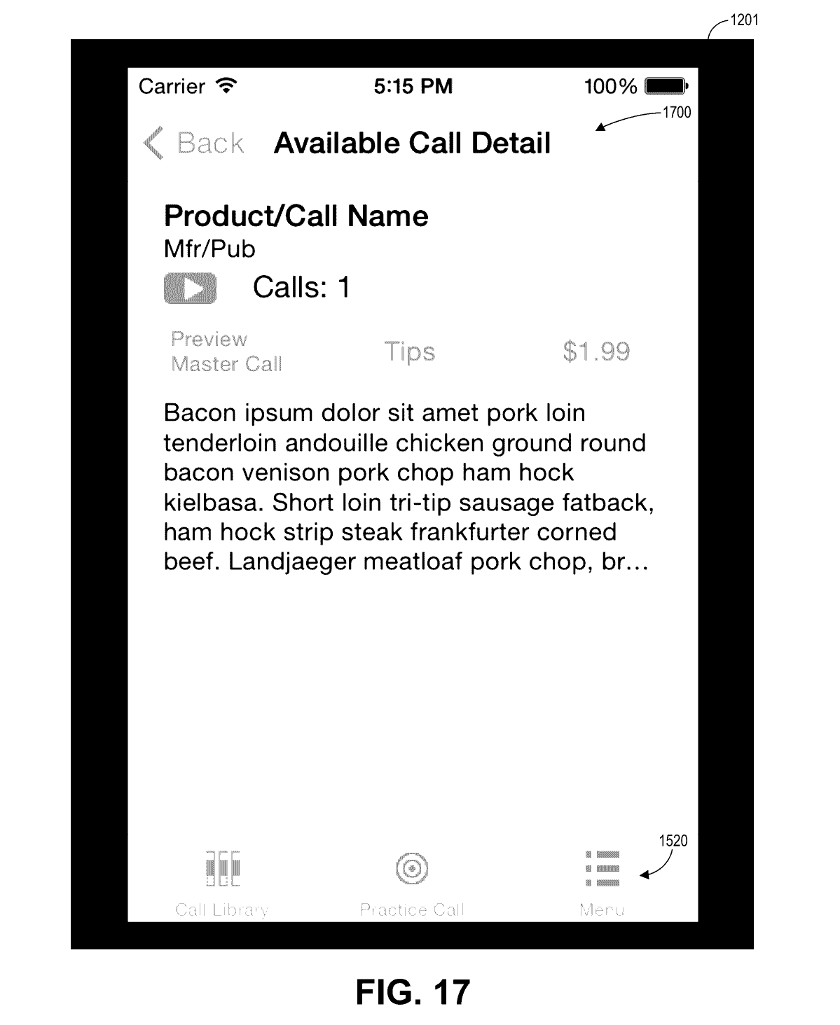

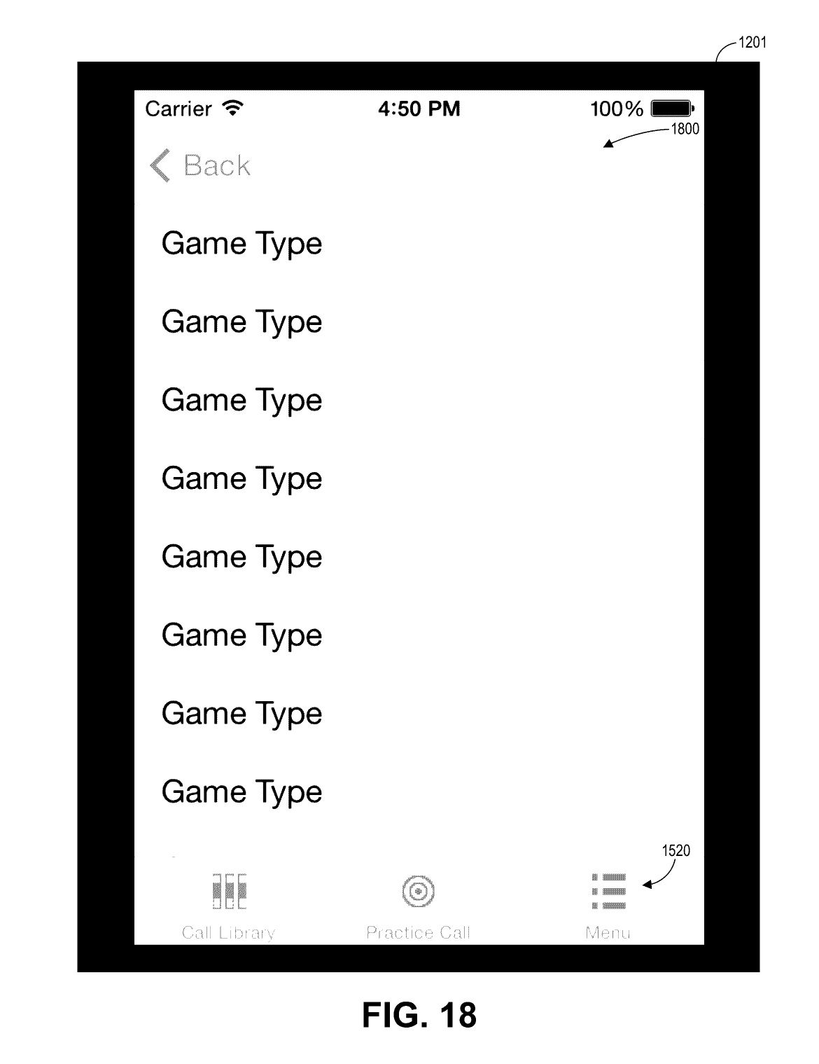

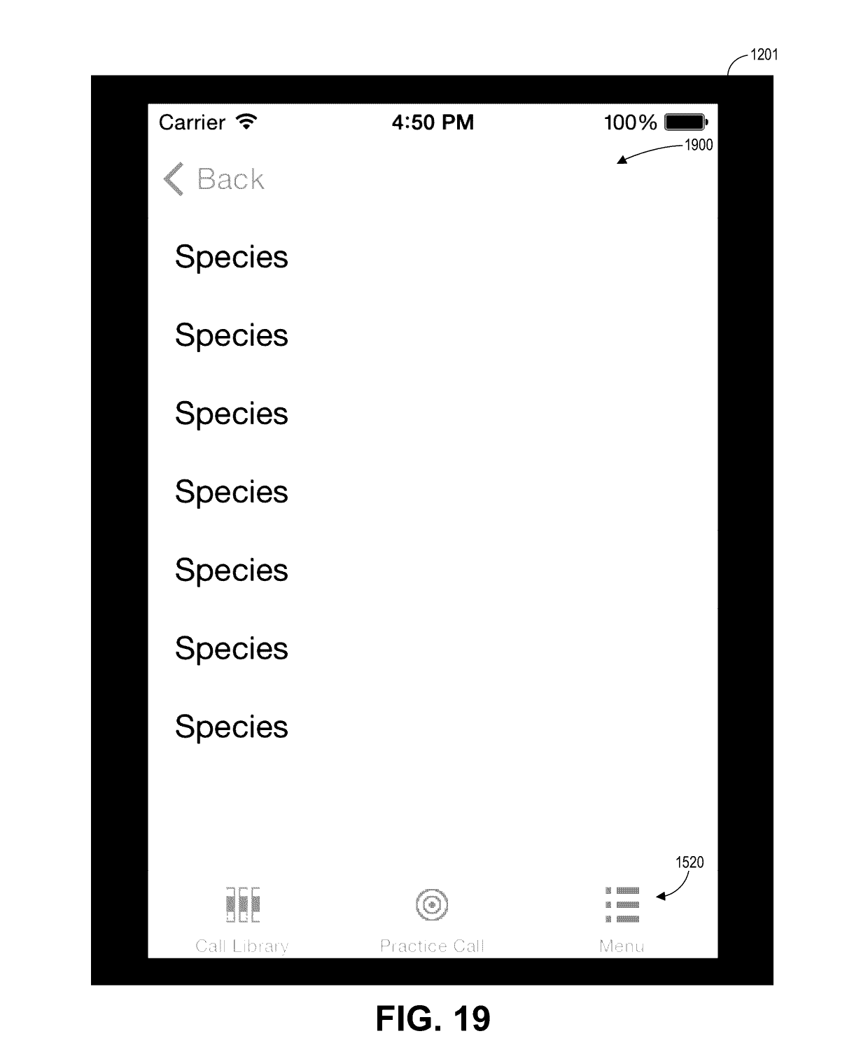

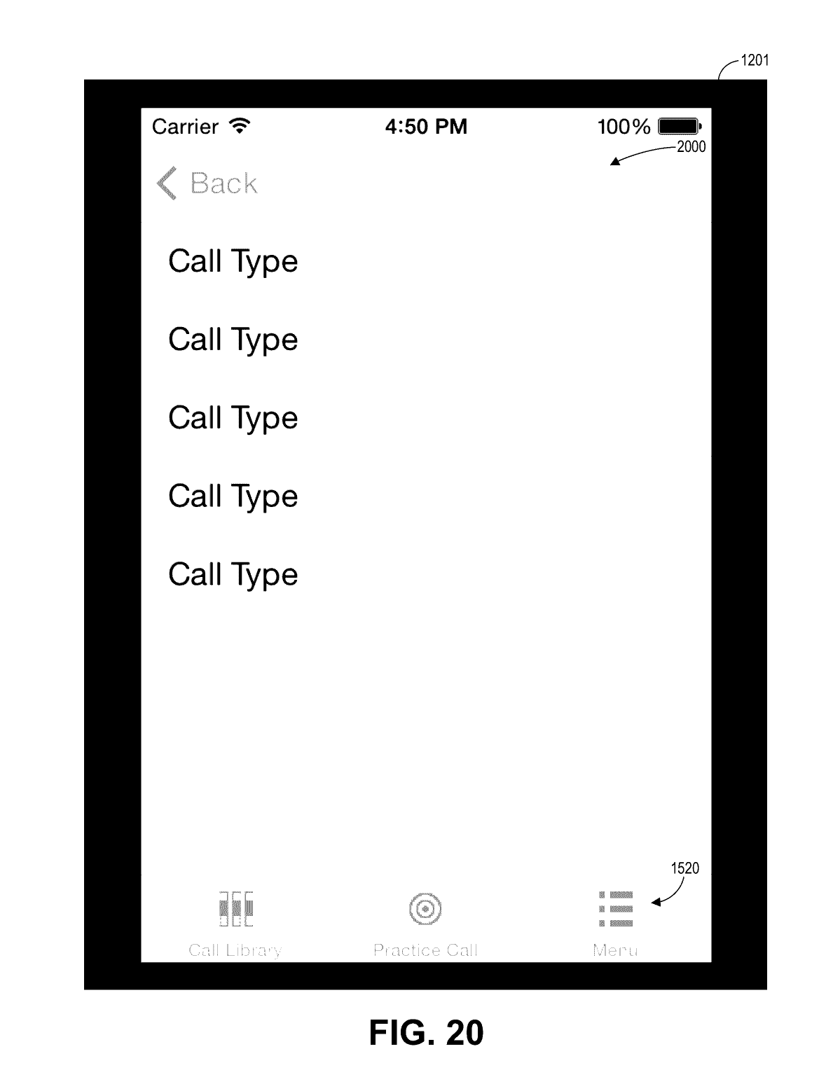

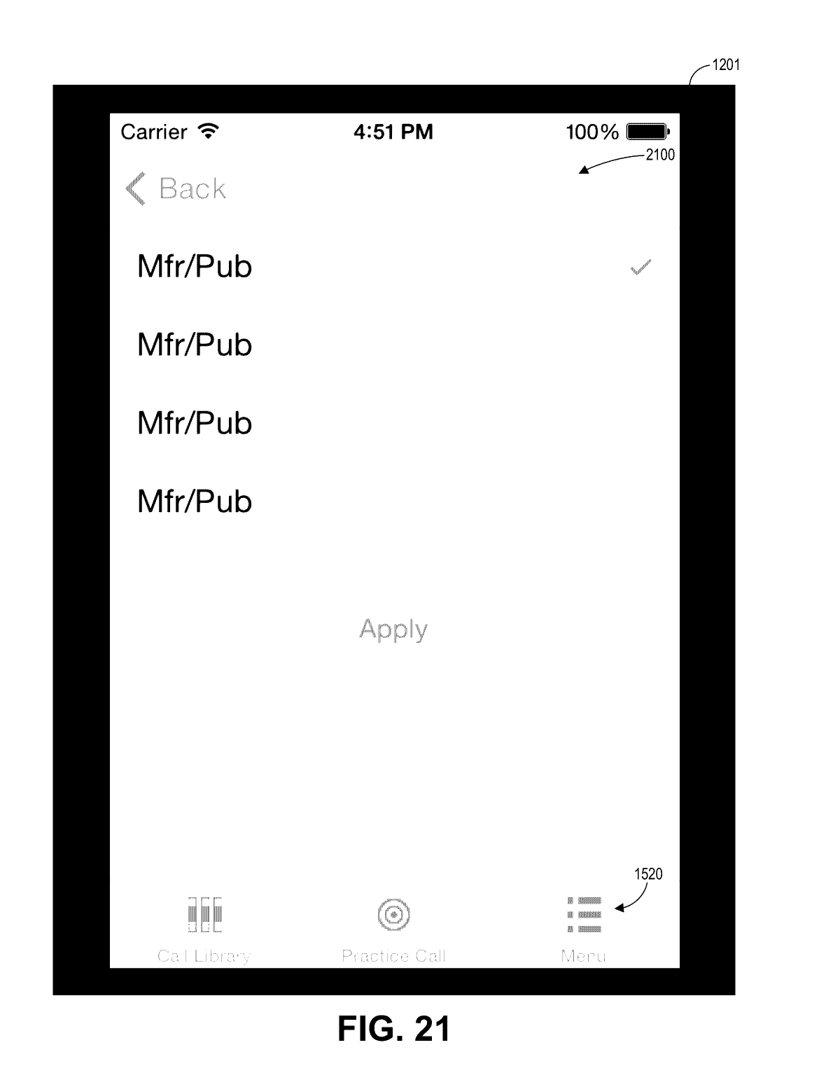

FIG. 16 depicts a user interface 1600 showing available calls for purchase, streaming, or download which may be accessed by selecting the available calls menu item 1510 from FIG. 15. FIG. 17 depicts the user interface 1700 with details about a selected one of the available calls from FIG. 16. Lorum ipsum text is used in FIG. 17 and certain other FIGURES herein but would be replaced with specific information relevant to the product or call in an example implementation. Calls may be selected by traversing a hierarchy of categories, starting with a game type (or animal type) category in the user interface 1800 of FIG. 18. The text “game type” is shown but may be replaced with actual types of game in an example implementation, such as fowl, big game, small game, and so on. Selection of one of the game types in FIG. 18 can result in a user interface 1900 of FIG. 19 being shown, which shows “species” categories that may be subcategories of the selected game type. Selection of one of species categories (such as turkey, elk, duck, etc.) can cause a user interface 2000 of FIG. 20 to be displayed, which shows different call type subcategories of the selected species categories. Further selection of one of these call types can cause a user interface 2100 of FIG. 21 to be displayed, which shows different calls corresponding to call instruments based on the manufacturer of the call instruments. A user can select one of these calls to download or purchase the call.

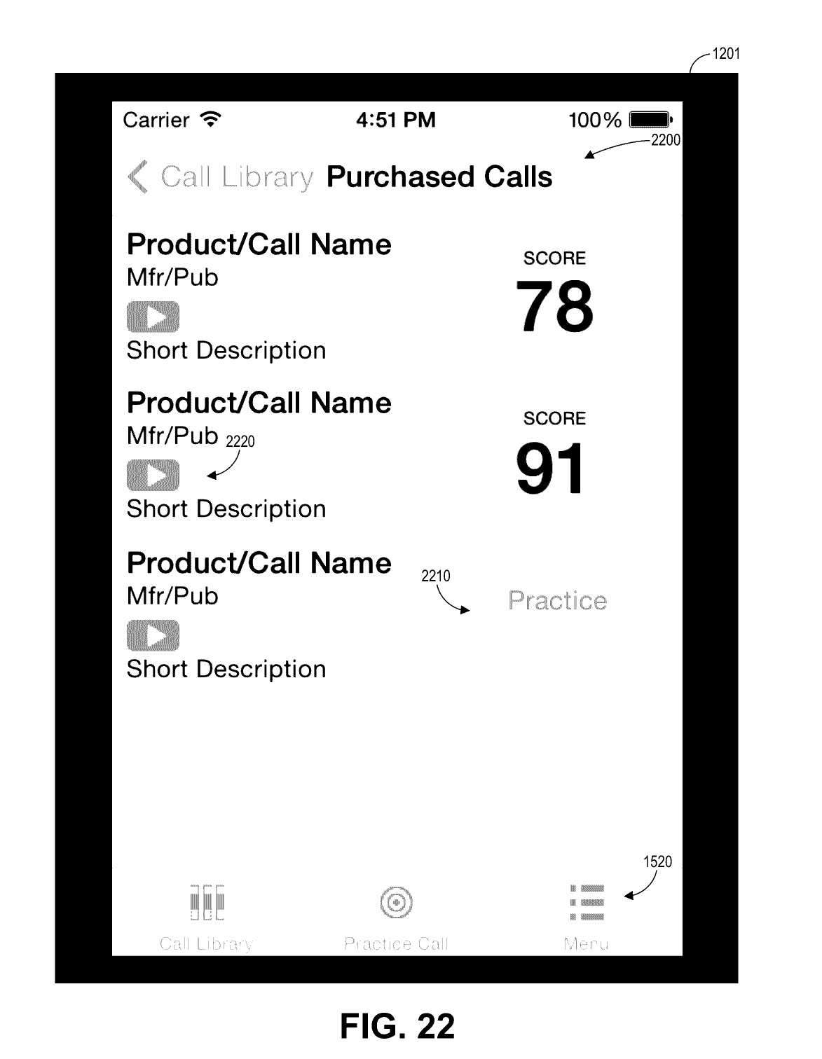

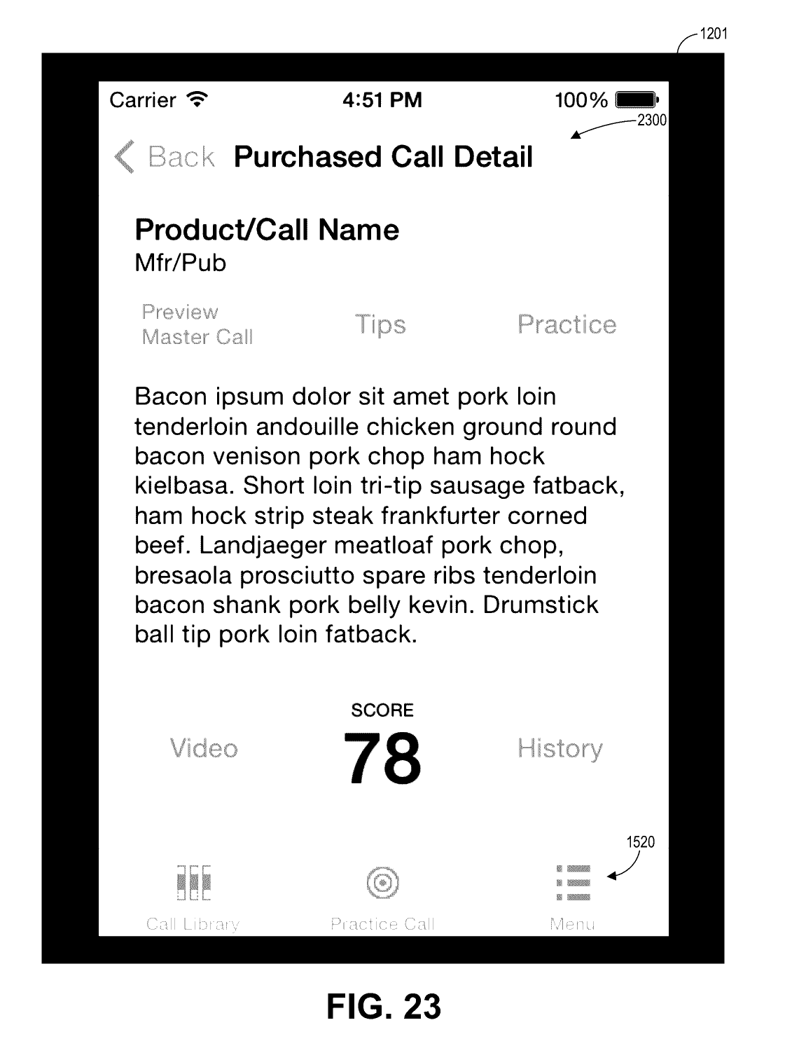

FIG. 22 shows a user interface 2200 with details about purchased calls the user has already purchased, including names of the products, average scores of previous attempts at practicing those calls, and a button 2210 for practicing a call. Buttons 2220 are also provided for each call to access a video or instructional material for the call. Videos may not be available for all calls. FIG. 23 depicts the user interface 2300 with call details about a purchased call in the user's call collection, with various buttons for previewing the master call, accessing tips about the call, practicing the call, viewing a video about the call, accessing the user's score history of the call, and the like. The user's most recent score with the call is also shown.

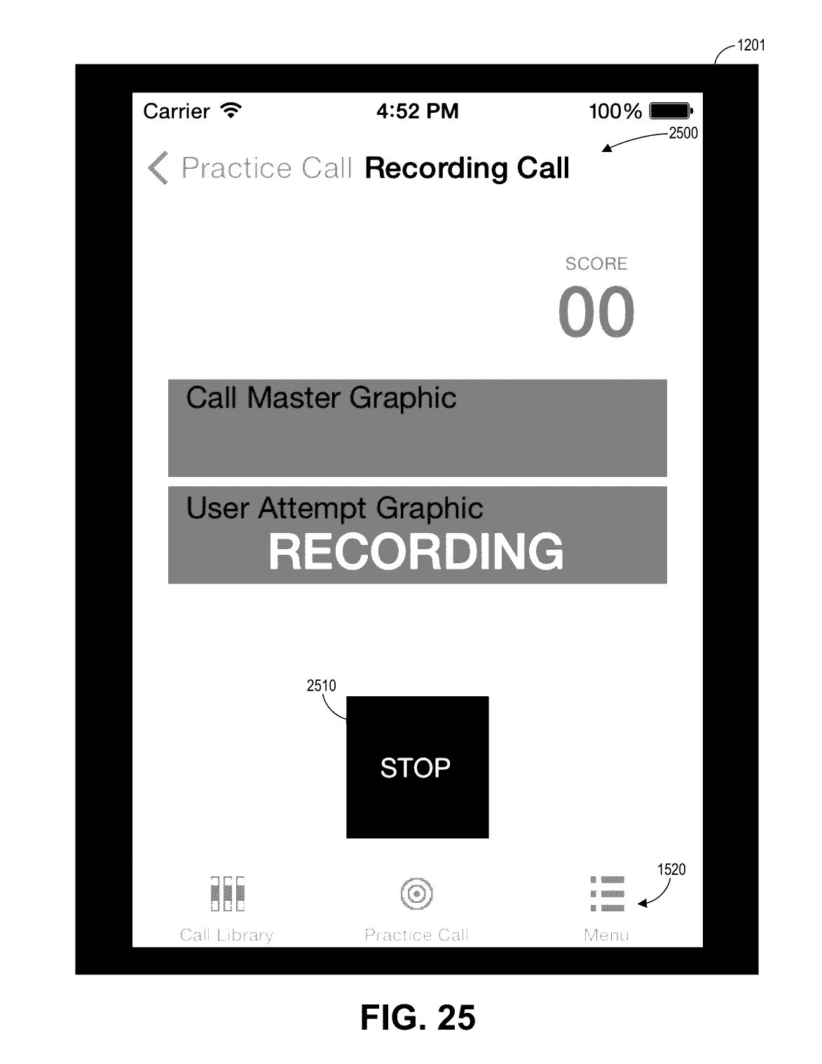

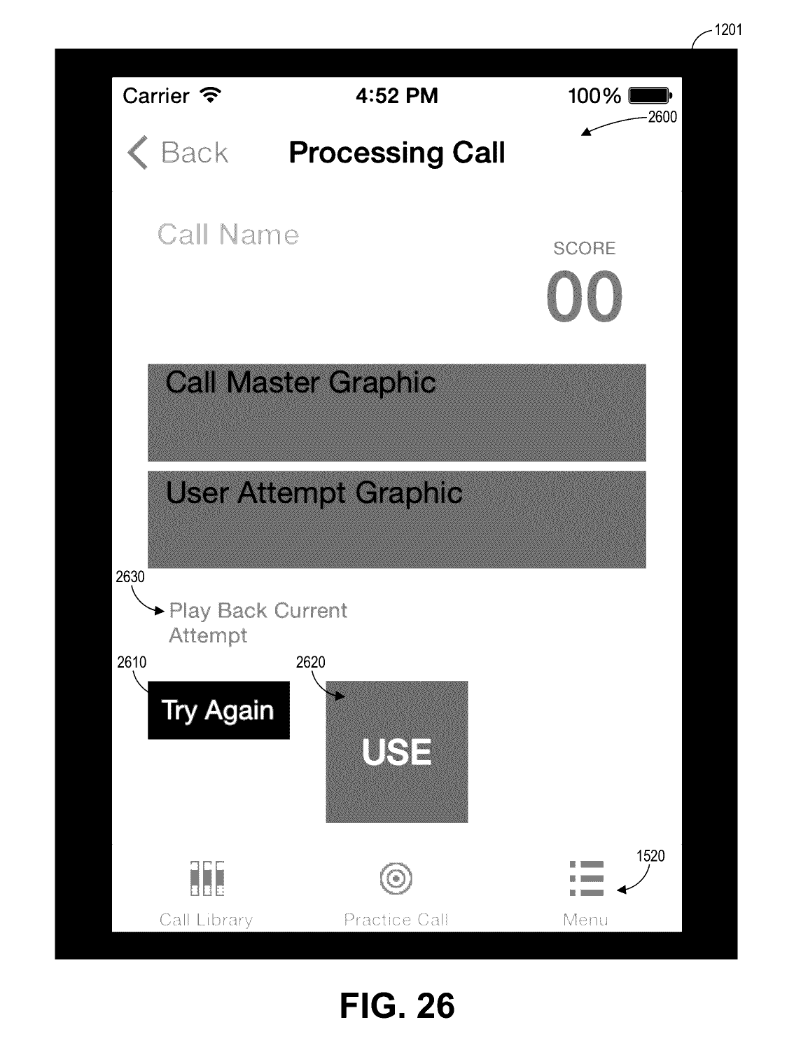

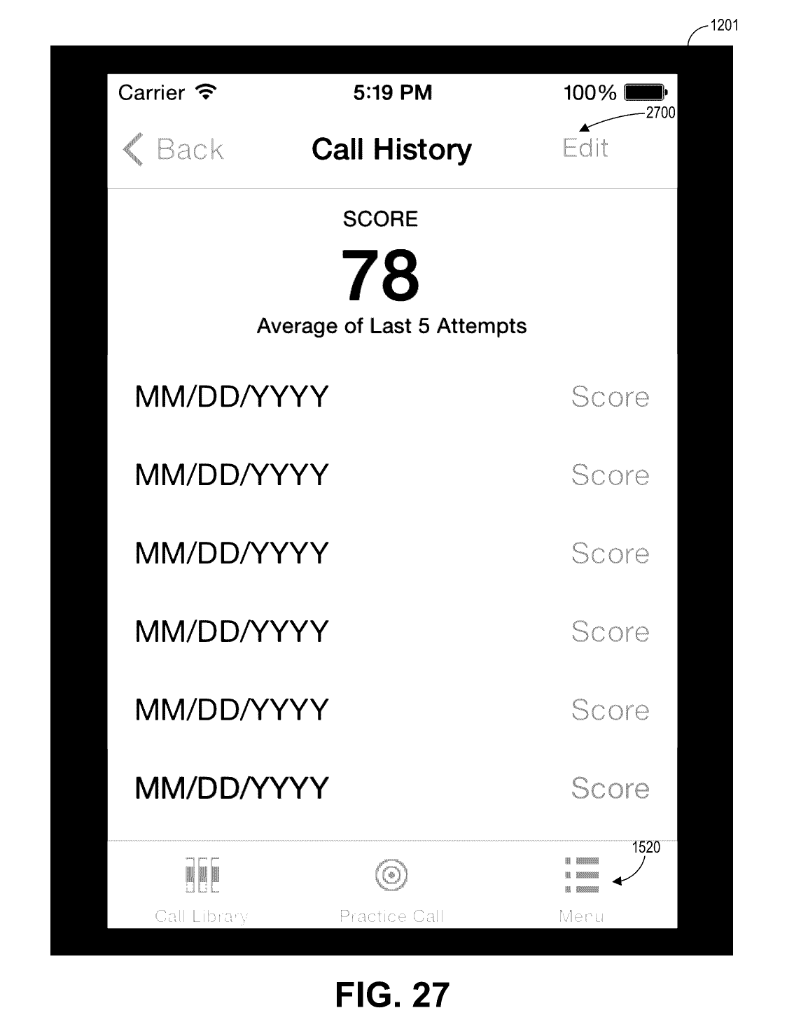

User selection of a practice call button from any of the above-described screens can result in a practice call interface 2400 of FIG. 24 being displayed. In the practice call interface 2400, buttons are again provided for previewing the master call, accessing tips, video, and history of scores for that call. In addition, a call master graphic 2410 and a user attempts graphic 2420 are shown. When the user selects a record button 2430, the call trainer application 112 can record a practice call, which can cause the user attempts graphic 2420 to be shown in proximity to the call master graphic 2410 for comparison. This visual comparison between graphics 2410, 2420 can help a user get a sense of how well the user is comparing with the master call. FIG. 25 depicts a user interface 2500 similar to the user interface 2400, which represents the user recording a practice call. A stop button 2510 is provided to stop the recording. FIG. 26 depicts a user interface 2600 similar to the previous two interfaces, representing when a user has selected the stop button 2510 in FIG. 25. A try again button 2610 is provided for the user to reattempt the practice call optionally without saving or evaluating the previous attempt, and a use button 2620 is provided for the user to request evaluation of the practice call with respect to the master call (e.g., using any of the algorithms described above). A user may also select a button 2630 to play back the current attempt and listen to his or her own practice call. FIG. 27 depicts a user interface 2700 with example feedback for the practice call, including the average score of the last five attempts as well as a list of scores and corresponding dates of those attempts.

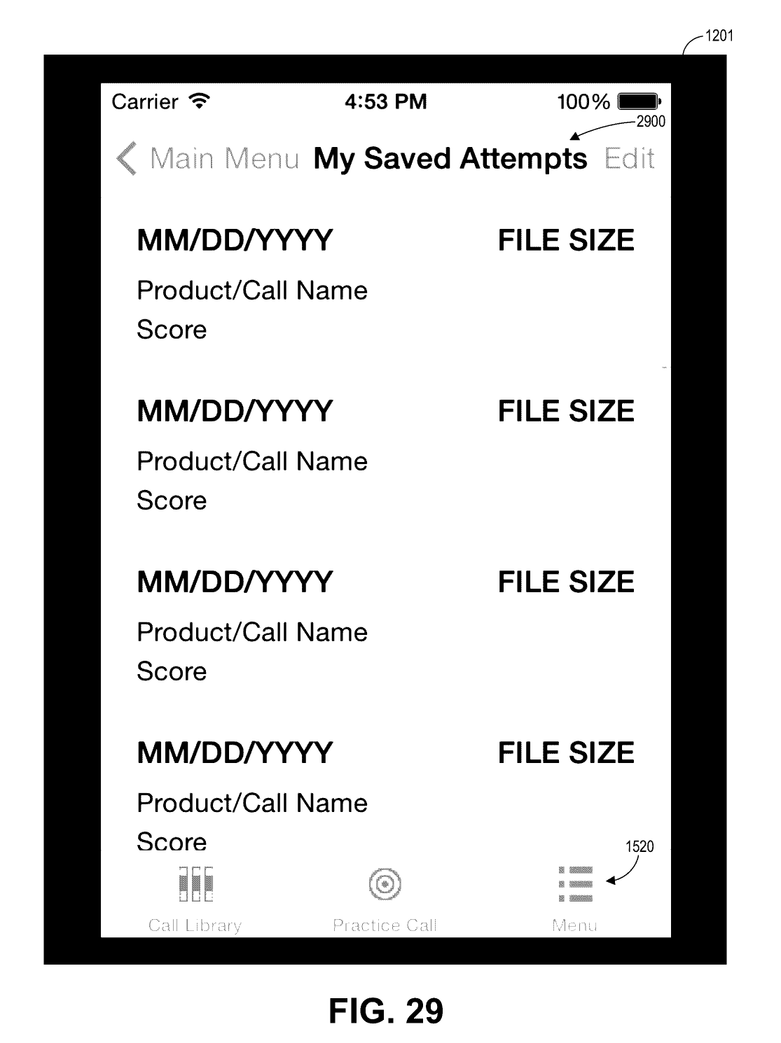

FIG. 28 provides a user interface 2800 with a main menu accessible by the menu options 1520. Through the user interface 2800, a user may select to practice a call, purchase calls, view available calls, view a user's saved attempts, edit the users profile, take a tutorial, and receive help for using the application. FIG. 29 shows a user interface 2900 with saved attempts that the user can access and play back to listen to the users previously-recorded practice calls.

### V. Additional Embodiments

To add variety and an element of competitiveness, the system 100 can present the practice session in a game environment or even as a separate game system. For example, in a game, an image of a target animal could be shown on the call trainer application 112 display, with the animal then moving closer (or fleeing) depending on the effectiveness of the practice call (or possibly even whether the correct call was selected for the simulated conditions). Scoring options and rankings based on user success can be integrated, as well as use of networking or social media to compete with friends and others.

### VI. Terminology

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

It is to be understood that not necessarily all such advantages can be achieved in accordance with any particular embodiment of the embodiments disclosed herein. Thus, the embodiments disclosed herein can be embodied or carried out in a manner that achieves or optimizes one advantage or group of advantages as taught herein without necessarily achieving other advantages as may be taught or suggested herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a hardware processor or digital logic circuitry, which may be or include a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry or digital logic circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Disjunctive language such as the phrase “at least one of X, Y and Z,” unless specifically stated otherwise, is to be understood with the context as used in general to convey that an item, term, etc. may be either X, Y, or Z, or a combination thereof. Thus, such conjunctive language is not generally intended to imply that certain embodiments require at least one of X, at least one of Y and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A method of conducting interactive training for producing a wildlife call, the method comprising:
electronically generating a wildlife call training user interface for output on a display of a computing device;
outputting master wildlife call audio associated with a master wildlife call with the computing device;
receiving practice audio input from a user via a microphone of the computing device, the practice audio input comprising data representing a practice wildlife call;
programmatically comparing at least one characteristic of the practice audio input with at least one characteristic of the master wildlife call audio;
assessing a quality of the practice wildlife call based at least in part on said comparing; and
electronically generating feedback output responsive to said assessing for presentation to the user.

2. The method of claim 1, wherein the at least one characteristic of the practice audio input comprises one or more of the following: volume, tone, pitch, rhythm, or length.

3. The method of claim 1, wherein the at least one characteristic of the practice audio input comprises a sound characteristic specific to an animal associated with the master wildlife call audio.

4. The method of claim 1, wherein the feedback comprises a score or rating.

5. The method of claim 4, wherein said programmatically comparing comprises applying a signal processing technique to analytically assess a degree of similarity between the at least one characteristic of the practice audio input with the at least one characteristic of the master wildlife call audio.

6. The method of claim 5, wherein the signal processing technique comprises performing a spectral conversion of the practice audio input to produce a spectrally-converted practice audio input and comparing the spectrally-converted practice audio input with a spectrally-converted version of the master wildlife call audio.

7. The method of claim 6, wherein said comparing of the spectrally-converted practice audio input with the spectrally-converted version of the master wildlife call audio comprises calculating a minimum mean square error between the spectrally-converted practice audio input with the spectrally-converted version of the master wildlife call audio.

8. The method of claim 5, wherein the signal processing technique comprises performing a mel spectrum analysis of the practice audio input and the master wildlife call audio.

9. The method of claim 1, wherein said programmatically comparing comprises sending the practice audio input to a remote server and receiving data representing a comparison of the practice audio input and the master wildlife call from the remote server.

10. The method of claim 1, further comprising receiving the master wildlife call as audio input from a second user.

11. The method of claim 1, further comprising downloading or streaming the master wildlife call from a remote server.

12. The method of claim 1, further comprising outputting an image of an animal that flees based on the feedback being negative.

13. A system for conducting interactive training for producing a wildlife call, the system comprising:
a computing device comprising a hardware processor programmed with specific executable instructions configured to:
output audio associated a master call comprising a reproduction of a call made by an animal;
receive recorded input audio corresponding to a practice call made by a user in attempting to mimic the master call;
programmatically compare the practice call with the master call; and
electronically generate feedback responsive to said comparison for presentation to the user.

14. The system of claim 13, wherein the feedback comprises a score or rating.

15. The system of claim 13, wherein the computing device is further configured to compare the practice call with the master call by comparing a characteristic of the practice call with a characteristic of the master call.

16. The system of claim 15, wherein the characteristic comprises one or more of the following: volume, tone, pitch, rhythm, or length of the practice call.

17. The system of claim 16, wherein the feedback comprises feedback regarding user performance on the characteristic.

18. The system of claim 17, wherein said programmatic comparison comprises a signal processing computation.

19. The system of claim 18, wherein the signal processing computation comprises a spectral conversion of the practice call to produce a spectrally-converted practice call, and wherein the signal processing computation further comprises a minimum mean square error calculation between the spectrally-converted practice call and a spectrally-converted version of the master call.

20. The system of claim 18, wherein the signal processing computation comprises a mel spectrum computation with respect to the practice call and the master call.
